(19) United States
(12) Patent Application Publication
(10) Pub. No.: US 2026/0238816 A1
(43) Pub. Date: Aug. 13, 2026

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventor: Jinwon LEE, Seoul (KR)

(73) Assignee: LG ELECTRONICS INC., Seoul (KR)

(21) Appl. No.: 19/471,668

(22) PCT Filed: Mar. 12, 2024
(86) PCT No.: PCT/KR2024/003181

§ 371 Date: Oct. 1, 2025

(30) Foreign Application Priority Data
Apr. 5, 2023 (KR) 10-2023-0044627

(51) Int. Cl. H04N 19/597; H04N 19/132; H04N 19/70

(52) U.S. Cl. CPC H04N 19/597; H04N 19/132; H04N 19/70

(57) ABSTRACT

A point cloud data transmission method according to embodiments may comprise the steps of: encoding point cloud data; encapsulating the point cloud data; and transmitting the point cloud data. A point cloud data reception method according to embodiments may comprise the steps of: receiving point cloud data; decapsulating the point cloud data; and decoding the point cloud data.

### CROSS-REFERENCE TO RELATED APPLICATION(S)

This application is the National Stage filing under 35 U.S.C. 371 of International Application No. PCT/KR2024/003181, filed on Mar. 12, 2024, which claims the benefit of earlier filing date and right of priority to Korean Application No. 10-2023-0044627, filed on Apr. 5, 2023, the contents of which are all incorporated by reference herein in their entirety.

### TECHNICAL FIELD

Embodiments relate to a method and apparatus for processing point cloud content.

### BACKGROUND

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### SUMMARY

Embodiments provide an apparatus and method for efficiently processing point cloud data. Embodiments provide a point cloud data processing method and apparatus for addressing latency and encoding/decoding complexity.

The embodiments are not limited to the aforementioned objects, and may also cover other objects that can be inferred by those skilled in the art based on the entire content disclosed herein.

To achieve these objects and other advantages and in accordance with the purpose of the disclosure, as embodied and broadly described herein, a method for transmitting point cloud data may include encoding point cloud data, encapsulating the point cloud data, and transmitting the point cloud data. In another aspect of the present disclosure, a method for receiving point cloud data may include receiving point cloud data, decapsulating the point cloud data, and decoding the point cloud data.

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary point cloud content providing system according to embodiments;

FIG. 2 is a block diagram illustrating a point cloud content providing operation according to embodiments;

FIG. 3 illustrates an exemplary process of capturing a point cloud video according to embodiments;

FIG. 4 illustrates an exemplary block diagram of point cloud video encoder according to embodiments;

FIG. 5 illustrates an example of voxels in a 3D space according to embodiments;

FIG. 6 illustrates an example of octree and occupancy code according to embodiments;

FIG. 7 illustrates an example of a neighbor node pattern according to embodiments;

FIG. 8 illustrates an example of point configuration of a point cloud content for each LOD according to embodiments;

FIG. 9 illustrates an example of point configuration of a point cloud content for each LOD according to embodiments;

FIG. 10 illustrates an example of a block diagram of a point cloud video decoder according to embodiments;

FIG. 11 illustrates an example of a point cloud video decoder according to embodiments;

FIG. 12 illustrates a configuration for point cloud video encoding of a transmission device according to embodiments;

FIG. 13 illustrates a configuration for point cloud video decoding of a reception device according to embodiments;

FIG. 14 illustrates an architecture for storing and streaming of G-PCC-based point cloud data according to embodiments;

FIG. 15 illustrates an example of storage and transmission of point cloud data according to embodiments;

FIG. 16 illustrates an example of a reception device according to embodiments;

FIG. 17 illustrates an exemplary structure operatively connectable with a method/device for transmitting and receiving point cloud data according to embodiments;

FIG. 18 illustrates TLV encapsulation of a G-PCC bitstream according to embodiments;

FIG. 19 illustrates a sequence parameter set (SPS) included in a bitstream according to embodiments;

FIG. 20 illustrates a tile parameter set (TPS) or tile inventory included in a bitstream according to embodiments;

FIG. 21 illustrates a geometry parameter set (GPS) included in a bitstream according to embodiments;

FIG. 22 illustrates an attribute parameter set (APS) included in a bitstream according to embodiments;

FIG. 23 illustrates a geometry data unit and a geometry data unit header included in a bitstream according to embodiments;

FIG. 24 illustrates an attribute data unit and an attribute data unit header included in a bitstream according to embodiments;

FIG. 25 illustrates the structure of a sample, when an encoded G-PCC bitstream is stored in a single track according to embodiments;

FIG. 26 illustrates a multi-track container for a G-PCC bitstream according to embodiments;

FIG. 27 illustrates the structure of a sample in a track carrying only a G-PCC geometry bitstream according to embodiments;

FIG. 28 illustrates a signaling method for a spatial region based on level of detail information according to embodiments;

FIG. 29 illustrates a method of transmitting point cloud data according to embodiments; and

FIG. 30 illustrates a method of receiving point cloud data according to embodiments.

### DETAILED DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

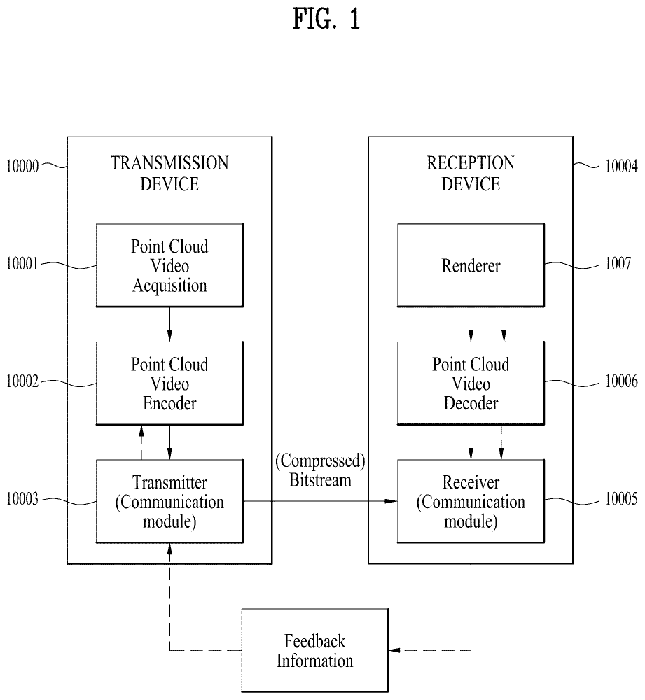

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video decoder 10006 may perform a decoding operation based on the feedback information. The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, or the like, and the reception device 10004 may be called a decoder, a receiving device, a receiver, or the like.

The point cloud data processed in the point cloud content providing system of FIG. 1 according to embodiments a series of (through processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

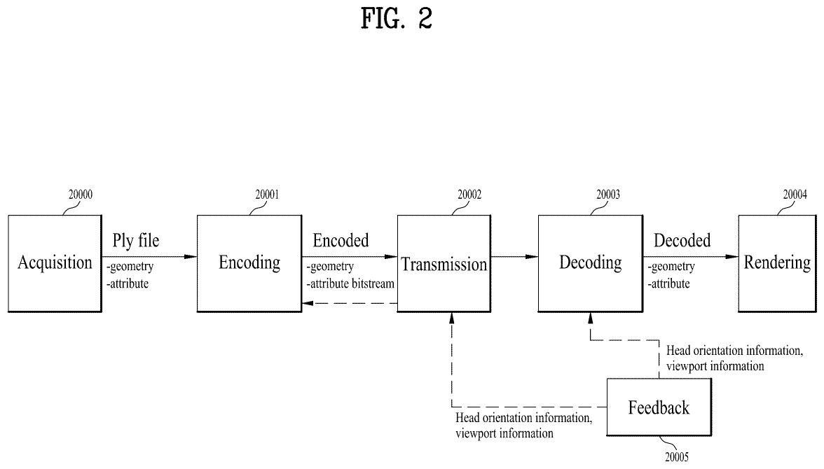

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (for example, the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like. The point cloud content providing system (for example, the point cloud transmission device 10000 or the point cloud video acquisition unit 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (for example, the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

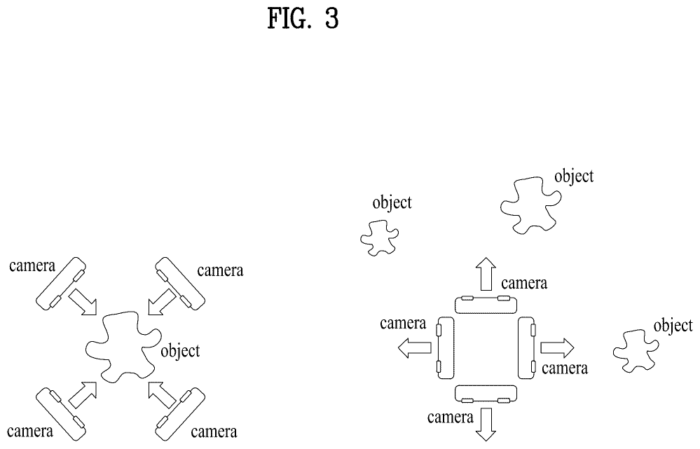

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in the figure, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

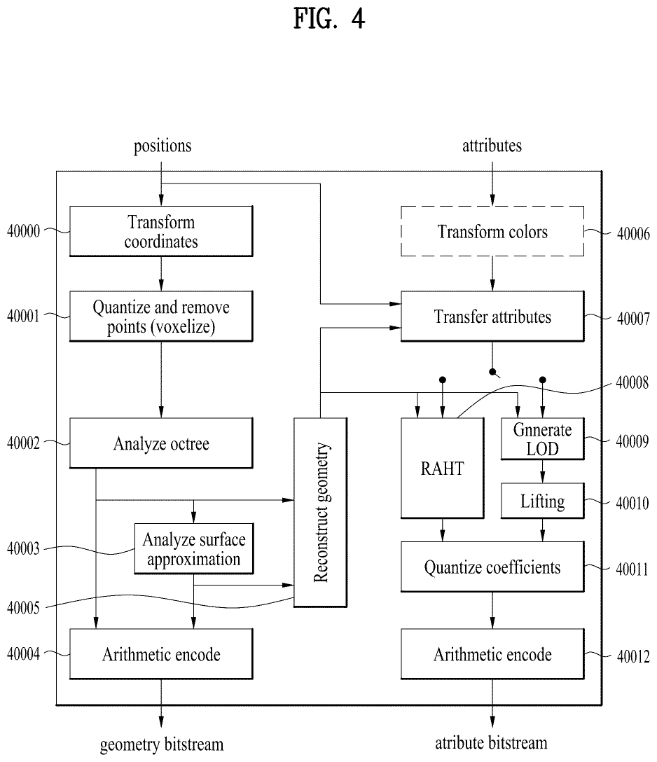

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud video encoder may perform geometry encoding and attribute encoding. The geometry encoding is performed before the attribute encoding.

The point cloud video encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometric reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry. For example, the quantizer 40001 may quantize the points based on a minimum position value of all points (for example, a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

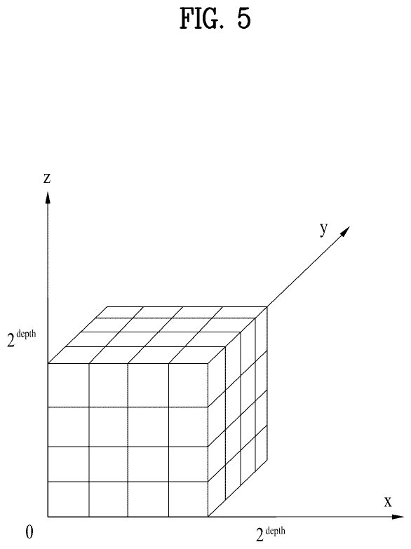

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2d, 2d, 2d) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

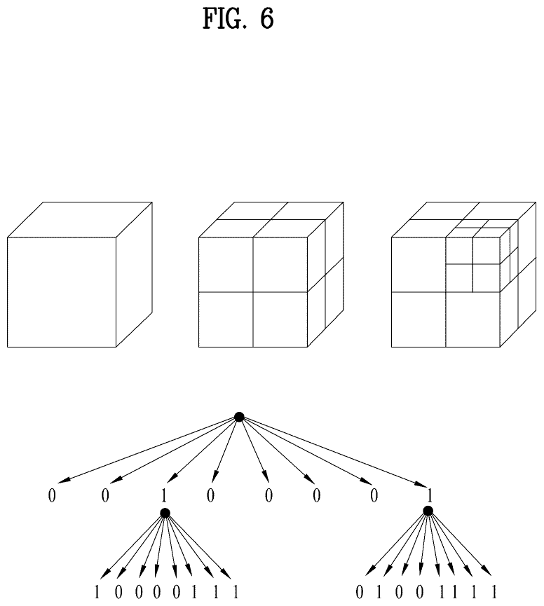

FIG. 6 shows an example of an octree and occupancy code according to embodiments.

As described with reference to FIGS. 1 to 4, the point cloud content providing system (point cloud video encoder 10002) or the point cloud video encoder (e.g., the octree analyzer 40002) performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2d, 2d, 2d). Here, 2d may be set to a value constituting the smallest bounding box surrounding all points of the point cloud content (or point cloud video). Here, d denotes the depth of the octree. The value of d is determined in the equation below. In the equation below, (xintn, yintn, zintn) denotes the positions (or position values) of quantized points.

$$d = Ceil ( Log 2 ( Max ( {x}_{n}^{int} , {y}_{n}^{int} , {z}_{n}^{int} , n = 1 , … , N ) + 1 ) )$$

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (for example, the arithmetic encoder 40004) according to the embodiments may perform entropy encoding on the occupancy codes. In order to increase the compression efficiency, the point cloud video encoder may perform intra/inter-coding on the occupancy codes. The reception device (for example, the reception device 10004 or the point cloud video decoder 10006) according to the embodiments reconstructs the octree based on the occupancy codes.

The point cloud video encoder (for example, the point cloud encoder of FIG. 4 or the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (for example, the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (for example, the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to the equations given below by: i) calculating the centroid value of each vertex, ii) subtracting the center value from each vertex value, and iii) estimating the sum of the squares of the values obtained by the subtraction.

$$\text{?} [ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] \text{?} [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] \text{?} [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ]$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of 0 is estimated through atan2(bi, ai), and the vertices are ordered based on the value of 0. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 2-1
Triangles formed from vertices ordered 1, . . . , n

| n | triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), |
| | (5, 7, 9), (9, 1, 5) |
| 11 | (1, 2, 3), (3, 4, 5), (5, 6, 7), (7, 8, 9), (9, 10, 11), |
| | (11, 1, 3), (3, 5, 7), (7, 9, 11), (11, 3, 7) |
| 12 | (1, 2, 3), (3, 4, 5), (5, 6, 7), (7, 8, 9), (9, 10, 11), |
| | (11, 12, 1), (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

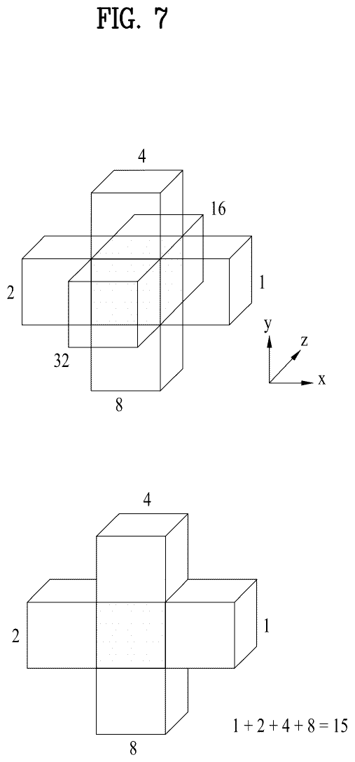

FIG. 7 shows an example of a neighbor node pattern according to embodiments.

In order to increase the compression efficiency of the point cloud video, the point cloud video encoder according to the embodiments may perform entropy coding based on context adaptive arithmetic coding.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 23=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The up part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (for example, based on a table by which 64 is changed to 10 or 6).

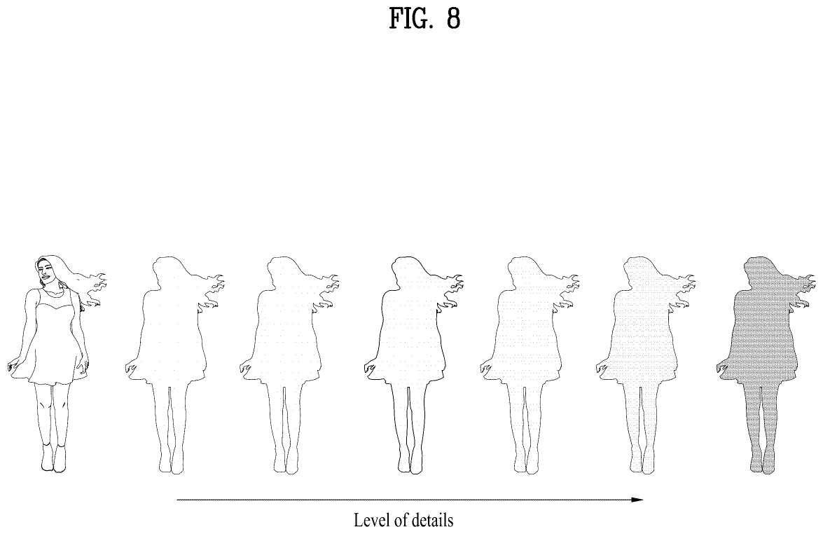

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (for example, the LOD generator 40009) may classify (reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

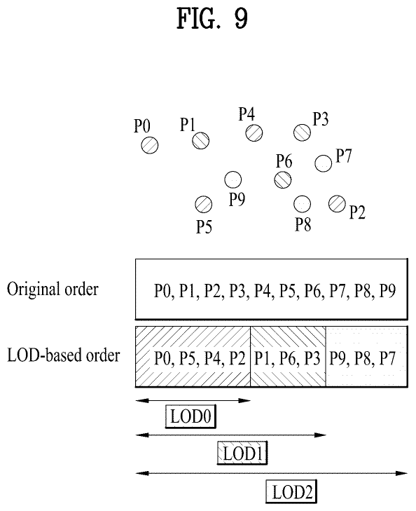

FIG. 9 illustrates an example of point configuration for each LOD according to embodiments.

As described with reference to FIGS. 1 to 8, the point cloud content providing system, or the point cloud video encoder (for example, the point cloud video encoder 10002 of FIG. 1, the point cloud video encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (for example, the coefficient quantizer 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in table 3.

TABLE Attribute prediction residuals quantization pseudo code
int PCCQuantization(int value, int quantStep) {
if( value >=0) {
return floor(value / quantStep + 1.0 / 3.0);
} else {
return −floor(−value / quantStep + 1.0 / 3.0);
}
}
TABLE Attribute prediction residuals inverse quantization pseudo code
int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual values as described above. When the predictor of each point has no neighbor point, the point cloud video encoder according to the embodiments (for example, the arithmetic encoder 40012) may perform entropy coding on the attributes of the corresponding point without performing the above-described operation.

The point cloud video encoder according to the embodiments (for example, the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.
1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.
2) Lift prediction process: Subtract the value obtained by multiplying the attribute value of the point by the weight from the existing attribute value to calculate a predicted attribute value.
3) Create temporary arrays called updateweight and update and initialize the temporary arrays to zero.
4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.
5) Lift update process: Divide the attribute values of the update array for all predictors by the weight value of the updateweight array of the predictor index, and add the existing attribute value to the values obtained by the division.
6) Calculate predicted attributes by multiplying the attribute values updated through the lift update process by the weight updated through the lift prediction process (stored in the QW) for all predictors. The point cloud video encoder (e.g., coefficient quantizer 40011) according to the embodiments quantizes the predicted attribute values. In addition, the point cloud video encoder (e.g., the arithmetic encoder 40012) performs entropy coding on the quantized attribute values.

The point cloud video encoder (for example, the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, g₁_{_{x,y,z}} denotes the average attribute value of voxels at level 1. g₁_{_{xyz}} may be calculated based on g₁₊₁_{_{2x,y,z}} and g₁₊₁_{_{2x+1,y,z}}. The weights for g₁_{_{2x,y,z}} and g₁_{_{2x+1,y,z}} are w1=w₁_{_{2x,y,z}} and w2=w₁_{_{2x+1,y,z}}

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, g₁₋₁_{_{x,y,z}} is a low-pass value and is used in the merging process at the next higher level. h₁₋₁_{_{x,y,z}} denotes high-pass coefficients. The high-pass coefficients at each step are quantized and subjected to entropy coding (for example, encoding by the arithmetic encoder 400012). The weights are calculated as w₁_{_{−1x,y,z}}=w₁_{_{2x,y,z}}+w₁_{_{2x+1,y,z}}. The root node is created through the g₁_{_{0,0,0}} and g₁_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

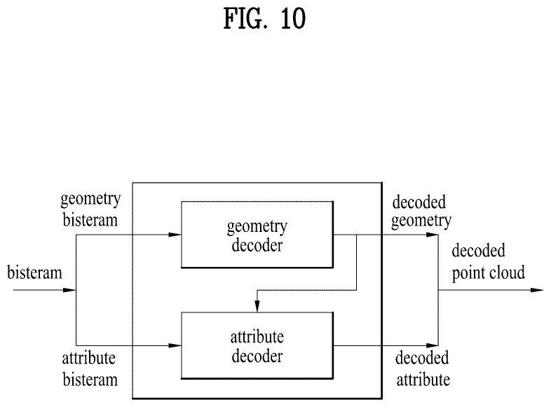

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

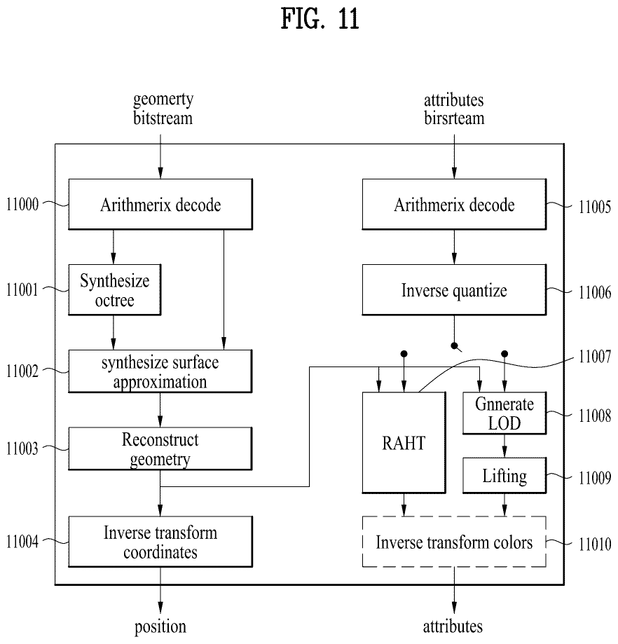

FIG. 11 illustrates a point cloud video decoder according to embodiments.

The point cloud video decoder illustrated in FIG. 11 is an example of the point cloud video decoder illustrated in FIG. 10, and may perform a decoding operation, which is an inverse process of the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

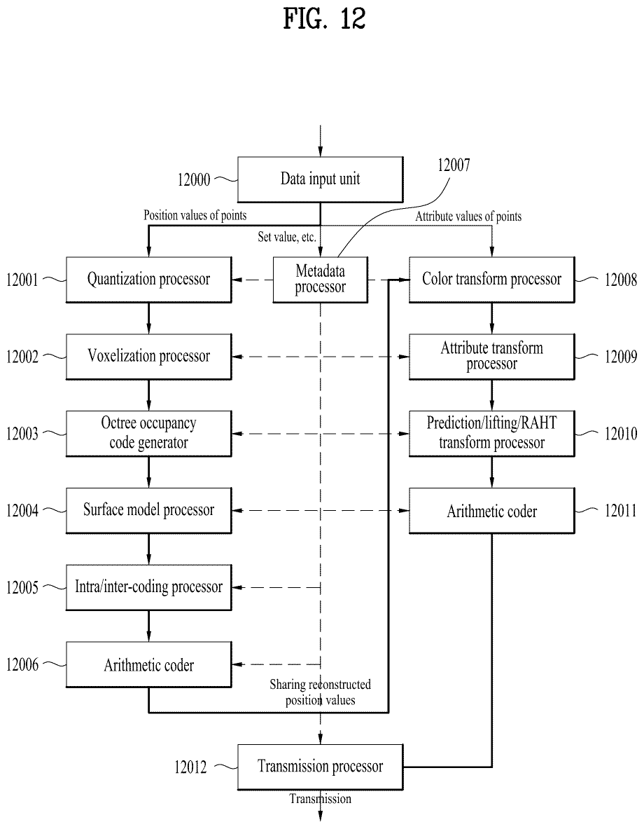

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 120002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud video encoder (for example, the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. The detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 400012.

The transmission processor 12012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom00 and one or more attribute bitstreams Attr00 and Attr10. The TPS according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

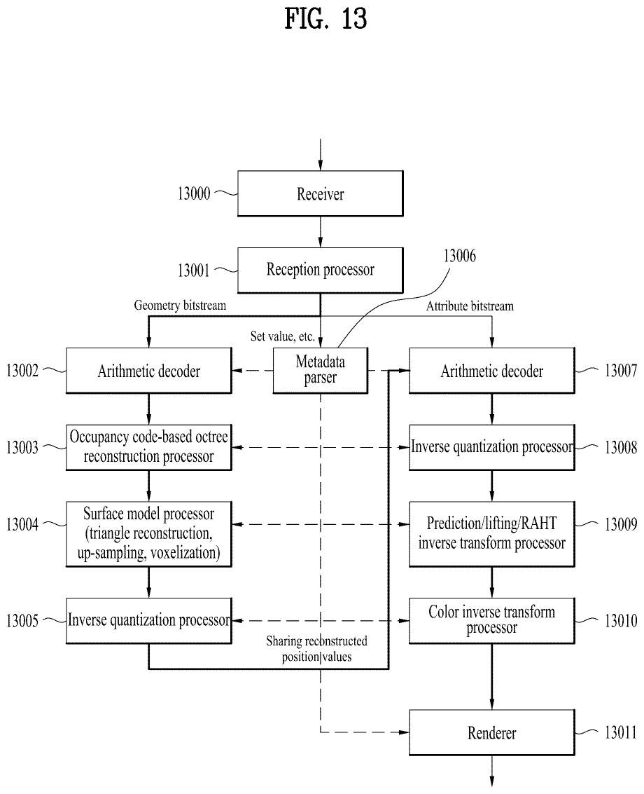

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform an inverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 1305 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 1302 according to the embodiments may perform trisoup geometry decoding and related geometry reconstruction (for example, triangle reconstruction, up-sampling, voxelization) based on the surface model method. The surface model processor 1302 performs an operation the same as or similar to that of the surface approximation synthesizer 11002 and/or the geometry reconstructor 11003.

The inverse quantization processor 1305 according to the embodiments may inversely quantize the decoded geometry.

The metadata parser 1306 according to the embodiments may parse metadata contained in the received point cloud data, for example, a set value. The metadata parser 1306 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transformer 13009 according to the embodiments may process the reconstructed geometry and the inversely quantized attributes. The prediction/lifting/RAHT inverse transform processor 1301 performs one or more of operations and/or decoding the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

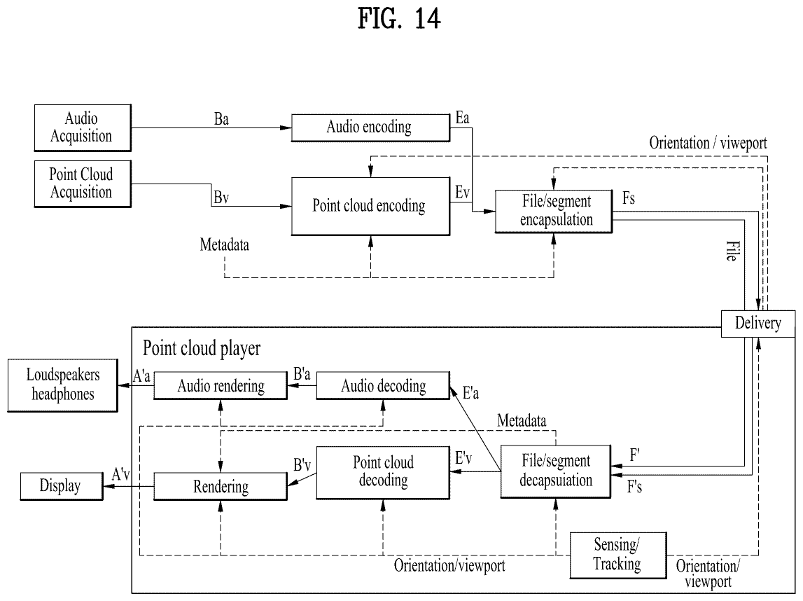

FIG. 14 illustrates an architecture for G-PCC-based point cloud content streaming according to embodiments.

The upper part of FIG. 14 shows a process of processing and transmitting point cloud content by the transmission device described in FIGS. 1 to 13 (for example, the transmission device 10000, the transmission device of FIG. 12, etc.).

As described with reference to FIGS. 1 to 13, the transmission device may acquire audio Ba of the point cloud content (Audio Acquisition), encode the acquired audio (Audio Encoding), and output an audio bitstream Ea. In addition, the transmission device may acquire a point cloud (or point cloud video) Bv of the point cloud content (Point Acquisition), and perform point cloud video encoding on the acquired point cloud to output a point cloud video bitstream Ev. The point cloud video encoding of the transmission device is the same as or similar to the point cloud video encoding described with reference to FIGS. 1 to 13 (for example, the encoding of the point cloud video encoder of FIG. 4), and thus a detailed description thereof will be omitted.

The transmission device may encapsulate the generated audio bitstream and video bitstream into a file and/or a segment (File/segment encapsulation). The encapsulated file and/or segment Fs, File may include a file in a file format such as ISOBMFF or a dynamic adaptive streaming over HTTP (DASH) segment. Point cloud-related metadata according to embodiments may be contained in the encapsulated file format and/or segment. The metadata may be contained in boxes of various levels on the ISO International Standards Organization Base Media File Format (ISOBMFF) file format, or may be contained in a separate track within the file. According to an embodiment, the transmission device may encapsulate the metadata into a separate file. The transmission device according to the embodiments may deliver the encapsulated file format and/or segment over a network. The processing method for encapsulation and transmission by the transmission device is the same as that described with reference to FIGS. 1 to 13 (for example, the transmitter 10003, the transmission step 20002 of FIG. 2, etc.), and thus a detailed description thereof will be omitted.

The lower part of FIG. 14 shows a process of processing and outputting point cloud content by the reception device (for example, the reception device 10004, the reception device of FIG. 13, etc.) described with reference to FIGS. 1 to 13.

According to embodiments, the reception device may include devices configured to output final audio data and final video data (e.g., loudspeakers, headphones, a display), and a point cloud player configured to process point cloud content (a point cloud player). The final data output devices and the point cloud player may be configured as separate physical devices. The point cloud player according to the embodiments may perform geometry-based point cloud compression (G-PCC) coding, video-based point cloud compression (V-PCC) coding and/or next-generation coding.

The reception device according to the embodiments may secure a file and/or segment F′, Fs′ contained in the received data (for example, a broadcast signal, a signal transmitted over a network, etc.) and decapsulate the same (File/segment decapsulation). The reception and decapsulation methods of the reception device is the same as those described with reference to FIGS. 1 to 13 (for example, the receiver 10005, the reception unit 13000, the reception processing unit 13001, etc.), and thus a detailed description thereof will be omitted.

The reception device according to the embodiments secures an audio bitstream E′a and a video bitstream E′v contained in the file and/or segment. As shown in the figure, the reception device outputs decoded audio data B′a by performing audio decoding on the audio bitstream, and renders the decoded audio data (audio rendering) to output final audio data A′a through loudspeakers or headphones.

Also, the reception device performs point cloud video decoding on the video bitstream E′v and outputs decoded video data B′v. The point cloud video decoding according to the embodiments is the same as or similar to the point cloud video decoding described with reference to FIGS. 1 to 13 (for example, decoding of the point cloud video decoder of FIG. 11), and thus a detailed description thereof will be omitted. The reception device may render the decoded video data and output final video data through the display.

The reception device according to the embodiments may perform at least one of decapsulation, audio decoding, audio rendering, point cloud video decoding, and point cloud video rendering based on the transmitted metadata. The details of the metadata are the same as those described with reference to FIGS. 12 to 13, and thus a description thereof will be omitted.

As indicated by a dotted line shown in the figure, the reception device according to the embodiments (for example, a point cloud player or a sensing/tracking unit in the point cloud player) may generate feedback information (orientation, viewport). According to embodiments, the feedback information may be used in a decapsulation process, a point cloud video decoding process and/or a rendering process of the reception device, or may be delivered to the transmission device. Details of the feedback information are the same as those described with reference to FIGS. 1 to 13, and thus a description thereof will be omitted.

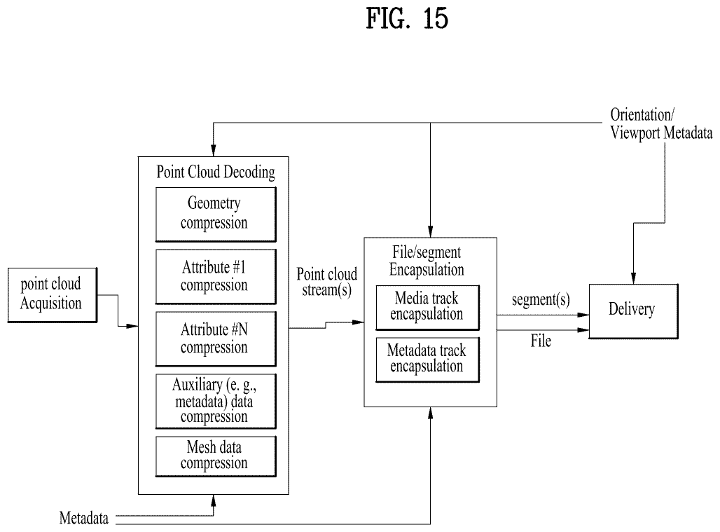

FIG. 15 shows an exemplary transmission device according to embodiments.

The transmission device of FIG. 15 is a device configured to transmit point cloud content, and corresponds to an example of the transmission device described with reference to FIGS. 1 to 14 (e.g., the transmission device 10000 of FIG. 1, the point cloud video encoder of FIG. 4, the transmission device of FIG. 12, the transmission device of FIG. 14). Accordingly, the transmission device of FIG. 15 performs an operation that is identical or similar to that of the transmission device described with reference to FIGS. 1 to 14.

The transmission device according to the embodiments may perform one or more of point cloud acquisition, point cloud video encoding, file/segment encapsulation and delivery.

Since the operation of point cloud acquisition and delivery illustrated in the figure is the same as the operation described with reference to FIGS. 1 to 14, a detailed description thereof will be omitted.

As described above with reference to FIGS. 1 to 14, the transmission device according to the embodiments may perform geometry encoding and attribute encoding. The geometry encoding may be referred to as geometry compression, and the attribute encoding may be referred to as attribute compression. As described above, one point may have one geometry and one or more attributes. Accordingly, the transmission device performs attribute encoding on each attribute. The figure illustrates that the transmission device performs one or more attribute compressions (attribute #1 compression, . . . , attribute #N compression). In addition, the transmission device according to the embodiments may perform auxiliary compression. The auxiliary compression is performed on the metadata. Details of the metadata are the same as those described with reference to FIGS. 1 to 14, and thus a description thereof will be omitted. The transmission device may also perform mesh data compression. The mesh data compression according to the embodiments may include the trisoup geometry encoding described with reference to FIGS. 1 to 14.

The transmission device according to the embodiments may encapsulate bitstreams (e.g., point cloud streams) output according to point cloud video encoding into a file and/or a segment. According to embodiments, the transmission device may perform media track encapsulation for carrying data (for example, media data) other than the metadata, and perform metadata track encapsulation for carrying metadata. According to embodiments, the metadata may be encapsulated into a media track.

As described with reference to FIGS. 1 to 14, the transmission device may receive feedback information (orientation/viewport metadata) from the reception device, and perform at least one of the point cloud video encoding, file/segment encapsulation, and delivery operations based on the received feedback information. Details are the same as those described with reference to FIGS. 1 to 14, and thus a description thereof will be omitted.

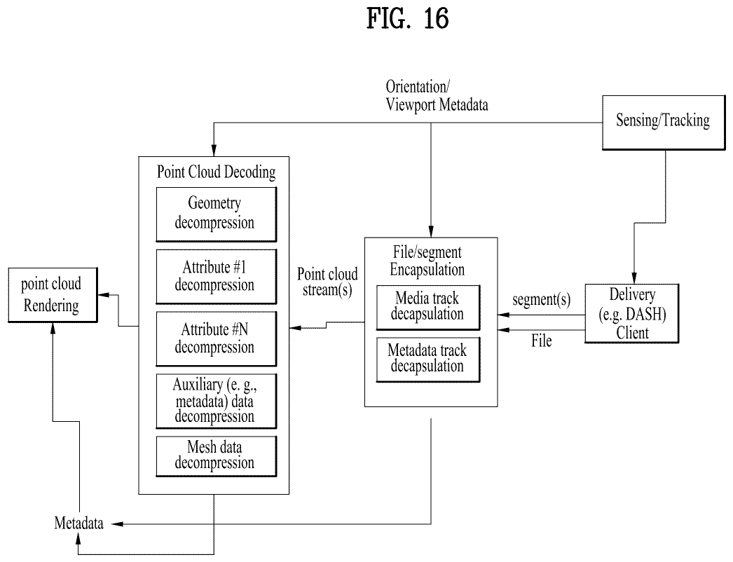

FIG. 16 shows an exemplary reception device according to embodiments.

The reception device of FIG. 16 is a device for receiving point cloud content, and corresponds to an example of the reception device described with reference to FIGS. 1 to 14 (for example, the reception device 10004 of FIG. 1, the point cloud video decoder of FIG. 11, and the reception device of FIG. 13, the reception device of FIG. 14). Accordingly, the reception device of FIG. 16 performs an operation that is identical or similar to that of the reception device described with reference to FIGS. 1 to 14. The reception device of FIG. 16 may receive a signal transmitted from the transmission device of FIG. 15, and perform a reverse process of the operation of the transmission device of FIG. 15.

The reception device according to the embodiments may perform at least one of delivery, file/segment decapsulation, point cloud video decoding, and point cloud rendering.

Since the point cloud reception and point cloud rendering operations illustrated in the figure are the same as those described with reference to FIGS. 1 to 14, a detailed description thereof will be omitted.

As described with reference to FIGS. 1 to 14, the reception device according to the embodiments decapsulates the file and/or segment acquired from a network or a storage device. According to embodiments, the reception device may perform media track decapsulation for carrying data (for example, media data) other than the metadata, and perform metadata track decapsulation for carrying metadata. According to embodiments, in the case where the metadata is encapsulated into a media track, the metadata track decapsulation is omitted.

As described with reference to FIGS. 1 to 14, the reception device may perform geometry decoding and attribute decoding on bitstreams (e.g., point cloud streams) secured through decapsulation. The geometry decoding may be referred to as geometry decompression, and the attribute decoding may be referred to as attribute decompression. As described above, one point may have one geometry and one or more attributes, each of which is encoded by the transmission device. Accordingly, the reception device performs attribute decoding on each attribute. The figure illustrates that the reception device performs one or more attribute decompressions (attribute #1 decompression, . . . , attribute #N decompression). The reception device according to the embodiments may also perform auxiliary decompression. The auxiliary decompression is performed on the metadata. Details of the metadata are the same as those described with reference to FIGS. 1 to 14, and thus a disruption thereof will be omitted. The reception device may also perform mesh data decompression. The mesh data decompression according to the embodiments may include the trisoup geometry decoding described with reference to FIGS. 1 to 14. The reception device according to the embodiments may render the point cloud data that is output according to the point cloud video decoding.

As described with reference to FIGS. 1 to 14, the reception device may secure orientation/viewport metadata using a separate sensing/tracking element, and transmit feedback information including the same to a transmission device (for example, the transmission device of FIG. 15). In addition, the reception device may perform at least one of a reception operation, file/segment decapsulation, and point cloud video decoding based on the feedback information. Details are the same as those described with reference to FIGS. 1 to 14, and thus a description thereof will be omitted.

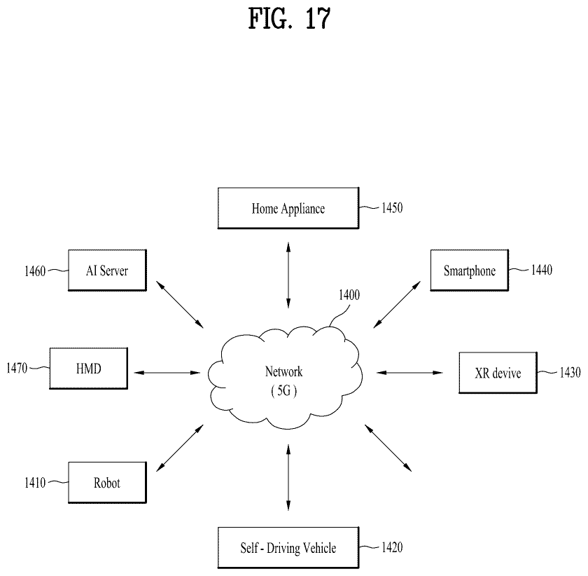

FIG. 17 shows an exemplary structure operatively connectable with a method/device for transmitting and receiving point cloud data according to embodiments.

The structure of FIG. 17 represents a configuration in which at least one of a server 1760, a robot 1710, a self-driving vehicle 1720, an XR device 1730, a smartphone 1740, a home appliance 1750, and/or a head-mount display (HMD) 1770 is connected to a cloud network 1710. The robot 1710, the self-driving vehicle 1720, the XR device 1730, the smartphone 1740, or the home appliance 1750 is referred to as a device. In addition, the XR device 1730 may correspond to a point cloud compressed data (PCC) device according to embodiments or may be operatively connected to the PCC device.

The cloud network 1700 may represent a network that constitutes part of the cloud computing infrastructure or is present in the cloud computing infrastructure. Here, the cloud network 1700 may be configured using a 3G network, 4G or Long Term Evolution (LTE) network, or a 5G network.

The server 1760 may be connected to at least one of the robot 1710, the self-driving vehicle 1720, the XR device 1730, the smartphone 1740, the home appliance 1750, and/or the HMD 1770 over the cloud network 1700 and may assist in at least a part of the processing of the connected devices 1710 to 1770.

The HMD 1770 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1710 to 1750 to which the above-described technology is applied will be described. The devices 1710 to 1750 illustrated in FIG. 17 may be operatively connected/coupled to a point cloud data transmission device and reception according to the above-described embodiments.

### <PCC+XR>

The XR/PCC device 1730 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1730 may analyze 3D point cloud data or image data acquired through various sensors or from an external device and generate position data and attribute data about 3D points. Thereby, the XR/PCC device 1730 may acquire information about the surrounding space or a real object, and render and output an XR object. For example, the XR/PCC device 1730 may match an XR object including auxiliary information about a recognized object with the recognized object and output the matched XR object.

### <PCC+Self-Driving+XR>

The self-driving vehicle 1720 may be implemented as a mobile robot, a vehicle, an unmanned aerial vehicle, or the like by applying the PCC technology and the XR technology.

The self-driving vehicle 1720 to which the XR/PCC technology is applied may represent a self-driving vehicle provided with means for providing an XR image, or a self-driving vehicle that is a target of control/interaction in the XR image. In particular, the self-driving vehicle 1720 which is a target of control/interaction in the XR image may be distinguished from the XR device 1730 and may be operatively connected thereto.

The self-driving vehicle 1720 having means for providing an XR/PCC image may acquire sensor information from sensors including a camera, and output the generated XR/PCC image based on the acquired sensor information. For example, the self-driving vehicle 1720 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1720 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

The point cloud data transmission/reception method/device according to the embodiments may be referred to as a method/device. Geometry may be referred to as geometry information, geometry data, and the like. An attribute may be referred to as attribute information, attribute data, and the like.

A point cloud or point cloud data refers to a set of points consisting of points defined by coordinates and zero or more attributes. A point cloud sequence is a sequence of point clouds. A point cloud frame refers to a point cloud within a point cloud sequence. Geometry is a set of points. An attribute is a scalar or vector property associated with each point of a point cloud, such as color, reflectance, or frame index. A slice is a unit of geometry and attributes within an encoded point cloud frame. A slice may correspond to a data unit. A tile is a set of slices. A GPCC track is a volumetric visual track that carries an encoded geometry bitstream, an encoded attribute bitstream, or both. A G-PCC tile base track is a volumetric visual track that carries a parameter set and tile inventory corresponding to a G-PCC tile track. A G-PCC tile track is a volumetric visual track that carries a G-PCC component corresponding to a G-PCC tile track. A G-PCC tile is a region within the bounding box of a point cloud frame that constitutes a group of slices. The G-PCC unit is a TLV encapsulation structure including at least one of an SPS, GPS, APS, tile inventory, or geometry/attribute data unit. A G-PCC geometry track is a volumetric visual track that carries an encoded geometry bitstream. A G-PCC attribute track is a volumetric visual track that carries an encoded attribute bitstream.

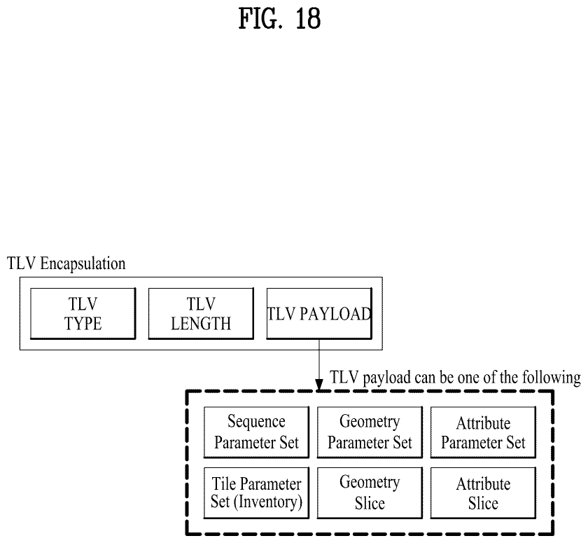

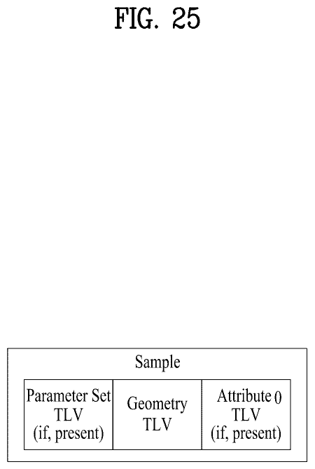

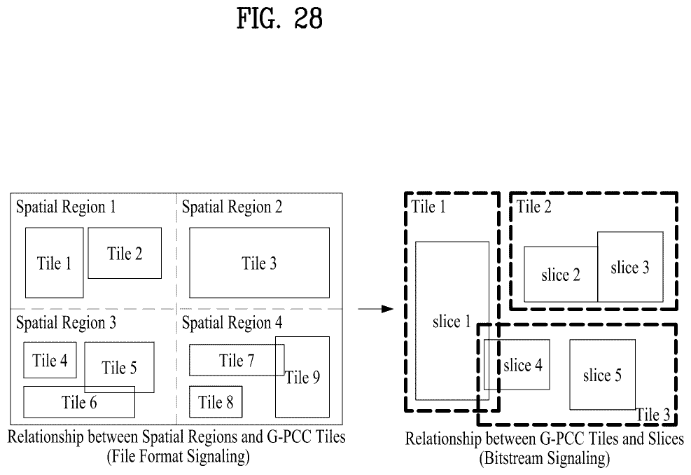

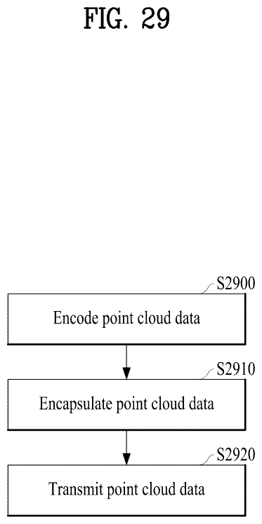

The point cloud data transmission method/device according to embodiments may include and perform the operations of the transmission device 10000 and point cloud video encoder 10002 of FIG. 1, the encoding 20001 of FIG. 2, the encoder of FIG. 4, the transmission device of FIG. 12, the audio encoding, point cloud encoding, file/segment encapsulation of FIG. 14, the point cloud encoding, file/segment encapsulation, delivery of FIG. 15, the various devices of FIG. 17, the bitstream generation of FIGS. 18 to 24, the sample entries and sample generation in tracks of a file of FIGS. 25 to 27, the level-of-detail signaling based on a spatial region of FIG. 28, and the transmission method of FIG. 29.

The point cloud data reception method/device according to embodiments may include and perform the operations of the reception device 10004, point cloud video decoder 10006 of FIG. 1, the decoding 20003 of FIG. 2, the decoders of FIGS. 10 and 11, the reception device of FIG. 13, the audio decoding, point cloud decoding, file/segment decapsulation of FIG. 14, the point cloud decoding, file/segment decapsulation of FIG. 16, the various devices of FIG. 17, the bitstream parsing of FIGS. 18 to 24, the sample entries and sample parsing in tracks of a file of FIGS. 25 to 27, the level-of-detail signaling based on a spatial region of FIG. 28, and the reception method of FIG. 29.

The method/device according to embodiments may include and perform G-PCC spatial region based level of detail signaling.

The method/device according to embodiments may include and perform frame-based level of detail (LoD) signaling for G-PCC content, spatial region-based LoD signaling for G-PCC content, and spatial region-based LoD signaling scheme for non-timed G-PCC data.

The embodiments include a transmitter or receiver for providing a point cloud content service that efficiently stores a G-PCC bitstream in a single track within a file and provides signaling thereof.

The embodiments include a transmitter or receiver for providing a point cloud content service that processes file storage techniques to support efficient access to stored G-PCC bitstreams.

The embodiments include, in addition to (or in modification/combination with) efficient storage of a G-PCC bitstream in a single track within a file and signaling thereof, and file storage techniques for supporting efficient access to stored G-PCC bitstreams, a method of splitting and storing a G-PCC bitstream into one or more tracks in a file.

G-PCC content may need to be decoded and played back at a lower precision than the original G-PCC content depending on the creator's intent and/or the performance and constraints of a point cloud receiver. To address this issue, embodiments may add and transmit level of detail (LoD) signaling at the file level. When G-PCC content is provided by a service such as streaming, selective decoding and rendering may be performed by referring to the signaled LoD values in a specific section, a specific frame, and/or a specific scene. That is, embodiments include a scheme of signaling dynamically varying LoD values at the file level on a frame-by-frame basis.

In addition, G-PCC content may be signaled at the file level as being divided into one or more 3D spatial regions, such that a point cloud receiver may partially select, within one frame of the G-PCC content, only a specific 3D spatial region to be decoded and rendered. The embodiments include a scheme of signaling the same or different levels of detail on a 3D spatial region basis.

Further, G-PCC content consisting of a single frame may be encapsulated as non-timed G-PCC data, i.e., a G-PCC item. Even in this case, partial access may be enabled based on 3D spatial regions, and thus the embodiments include a scheme of signaling the same or different LoD values based on each 3D spatial region. This may correspond to a case such as fused data configured by combining multiple frame data into a single frame.

The definitions of the respective abbreviations are as follows: APS (Attribute parameter set), ADU (Attribute data unit); CBS (Chunked bytestream); CPM (Contextual probability model); DU (Data unit); FBDU (Frame boundary marker data unit); FSAP (Frame-specific attribute properties); GDU (Geometry data unit); GPS (Geometry parameter set); G-PCC (Geometry-based point cloud compression); LoD (Level(s) of detail); LSB (Least significant bit); MSB (Most significant bit); NA (Not applicable); QP (Quantization parameter); RAHT (Region adaptive hierarchical transform); SPS (Sequence parameter set), 3D Tile (a rectangular cuboid region within a bounding box).

Geometry data constituting PCC content may be encoded and decoded on a slice basis, and an occupancy tree (which may be referred to as an octree that may have eight arrays) may be used during encoding, and may be signaled together with the depth level value of the occupancy tree.

The depth level value is an element occtree_depth_minus1 included in a geometry data unit header, and may indicate the maximum number of tree levels. When the receiver performs decoding at a lower depth level than the maximum number of tree levels, i.e., the maximum depth level, the G-PCC content may consequently be rendered at lower precision or with a lower level of detail. A G-PCC content creator may desire that, after a point cloud receiver receives the G-PCC content, decoding and rendering be performed by applying a higher or lower level of detail on a frame basis, that is, in a specific frame interval. Here, since the element occtree_depth_minus1 is signaled within the G-PCC bitstream and there is no external reference value, the point cloud receiver cannot know the intention of the G-PCC content creator regarding how to determine the level of detail for decoding and rendering. Accordingly, signaling for transmitting the level of detail value to be applied at a file level is to be defined and described. Two signaling methods may be defined, one using a sample group and another using a timed-metadata track.

In addition, embodiments include a scheme in which, when each frame constituting G-PCC content is composed of one or more 3D spatial regions, the level of detail value may be signaled on a per-3D-spatial-region basis. In the case where multiple objects are included in a frame, the scheme may apply different level of detail values to one or more 3D objects included in each 3D spatial region, thereby enabling decoding and rendering.

Geometry-based point cloud compression data represents volumetric encoding of a point cloud composed of a series of point cloud frames. Each point cloud frame includes the number of points, positions, and attributes, which may differ among frames.

Source point cloud data may be partitioned into multiple slices and encoded into a bitstream. A slice is a set of points that can be independently encoded or decoded. Geometry and attribute information of each slice can be independently encoded or decoded. A tile is a group of patches that includes bounding box information. The bounding box information of each tile is specified in a tile inventory. Tiles may overlap with other tiles of the bounding box. Each patch includes an index identifying the tile to which it belongs.

The G-PCC bitstream may be composed of parameter sets (e.g., sequence parameter set, geometry parameter set, attribute parameter set), geometry slices, or attribute slices.

The G-PCC TLV encapsulation structure represents a byte stream format for use in applications, consisting of a series of type-length-value (TLV) encapsulation structures each representing a single coded syntax structure. Each TLV encapsulation structure includes a payload type, payload length, and payload bytes as described below.

TABLE 1

| | Descriptor |
|---|---|
| tlv_encapsulation( ) { | |
| tlv_type | u(8) |
| tlv_num_payload_bytes | u(32) |
| for( i = 0; i < tlv_num_payload_bytes; i++ ) | |
| tlv_payload_byte[ i ] | u(8) |
| } | |

tlv_type identifies a syntax structure represented by tlv_payload_byte[ ].

TABLE 2

| | Syntax | |
|---|---|---|
| tlv_type | table | Description |
| 0 | 7.3.2.1 | Sequence parameter set data unit |
| 1 | 7.3.2.5 | Geometry parameter set data unit |
| 2 | 7.3.3.1 | Geometry data unit |
| 3 | 7.3.2.6 | Attribute parameter set data unit |
| 4 | 7.3.4.1 | Attribute data unit |
| 5 | 7.3.2.4 | Tile inventory data unit |
| 6 | 7.3.2.8 | Frame boundary marker data unit |
| 7 | 7.3.5 | Defaulted attribute data unit |
| 8 | 7.3.2.7 | Frame-specific attribute properties data unit |
| 9 | 7.3.2.9 | User data data unit |

tlv_num_payload_bytes indicates the length (in bytes) of tlv_payload_byte[ ].

tlv_payload_byte[ i] is the i-th byte of the payload data.

FIG. 18 illustrates TLV encapsulation of a G-PCC bitstream according to embodiments.

As illustrated in FIG. 18, a G-PCC bitstream is configured as a series of TLV structures, each representing a single coded syntax structure (e.g., geometry payload, attribute payload, and a specific type of parameter set).

The point cloud data transmission method/device according to embodiments (the transmission device 10000 and the point cloud video encoder 10002 of FIG. 1, the encoding 20001 of FIG. 2, the encoder of FIG. 4, the transmission device of FIG. 12, the audio encoding and point cloud encoding of FIG. 14, the point cloud encoding of FIG. 15, and each device of FIG. 17) may encode point cloud data and generate parameter sets to generate the bitstream of FIG. 18.

The point cloud data reception method/device according to embodiments (the reception device 10004 and the point cloud video decoder 10006 of FIG. 1, the decoding 20003 of FIG. 2, the decoder of FIGS. 10 and 11, the reception device of FIG. 13, the audio decoding and point cloud decoding of FIG. 14, the point cloud decoding of FIG. 16, and each device of FIG. 17) may receive the bitstream of FIG. 18 and decode geometry slices and attribute slices based on the parameter sets.

A TLV payload decoding process is as follows: An input to this process is an ordered byte stream configured as a series of TLV encapsulation structures. An output of this process is a series of syntax structures. The decoder repeatedly parses tlv_encapsulation structures until the end of the byte stream is reached (determined by unspecified means) and the last NAL unit of the byte stream is decoded.

After parsing each tlv_encapsulation structure, the following occurs: A PayloadBytes array is set to be equal to tlv_payload_byte[ ]. A NumPayloadBytes variable is set to be equal to tlv_num_payload_bytes. A parsing process corresponding to tlv_type is invoked.

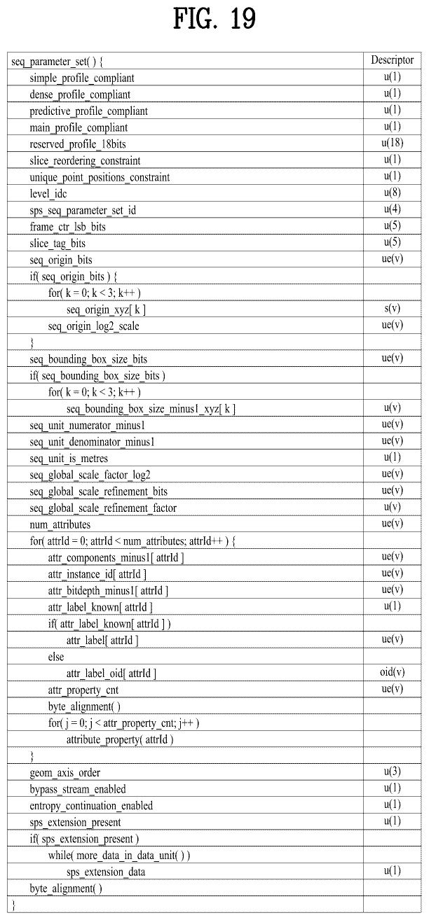

FIG. 19 illustrates an SPS included in a bitstream according to embodiments.

FIG. 19 illustrates the syntax of the SPS included in the bitstream of FIG. 18.

simple_profile_Compliance equal to 1 specifies that the bitstream complies with a simple profile. simple_profile_Compliance equal to 0 specifies that the bitstream complies with a profile other than the simple profile.

density_profile_Compliance equal to 1 specifies that the bitstream complies with a dense profile. density_profile_Compliance equal to 0 specifies that the bitstream complies with a profile other than the dense profile.

Predictive_profile_Compliance being 1 specifies that the bitstream complies with a predictive profile. Predictive_profile_Compliance being 0 specifies that the bitstream complies with a profile other than the predictive profile.

If main_profile_Compliance is 1, it specifies that the bitstream complies with a main profile. main_profile_Compliance being 0 specifies that the bitstream complies with a profile other than the main profile.

Reserved profile_18bits is equal to 0 in a bitstream conforming to this version of this document. Other values of Reserved profile 18bits are reserved for future use by ISO/IEC. The decoder ignores the value of Reserved profile_18bits.

Slice_reordering_constraint being 1 specifies that the bitstream is sensitive to slice reordering and removal. Slice_reordering_constraint being 0 specifies that the bitstream is not sensitive to slice reordering and removal.

Unique_point_positions_constraint being 1 specifies that all points in each coded point cloud frame should have unique positions. Unique_point_positions_constraint being 0 specifies that two or more points in a coded point cloud frame may have the same position.

For example, even if points in each slice have unique positions, points in different slices within a frame may coincide with each other. In this case, Unique_point_positions_constraint is set to 0.

Two points having the same position in the same frame with different frame index attribute values do not satisfy Unique_point_positions_constraint equal to 1.

sps_seq parameter_set_id identifies an SPS to be referenced by other DUs. sps_seq_parameter_set_id is 0 in a bitstream conforming to this version of this document. Other values of sps_seq_parameter_set_id are reserved for future use by ISO/IEC.

Frame_ctr_lsb_bits specifies the length, in bits, of a Frame_ctr_lsb syntax element.

Slice_tag_bits specifies the length, in bits, of a Slice_tag syntax element.

seq_origin_bits specifies the length, in bits, of each syntax element seq_origin_xyz[k].

seq_origin_xyz[k] and seq_origin_log 2_scale together specify a k-th origin component of a coding coordinate system. If not present, the values of seq_origin_xyz[k] and seq_origin_log 2_scale are inferred to be 0.

The origin of the coding coordinate system is specified by a SeqOrigin[k] expression.

$$Seq Origin [ k ] := seq\_origin \_xyz [ k ] << seq\_origin\_log2\_scale$$

seq_bounding_box_size_bits specifies the length, in bits, of each syntax element seq_bounding_box_size_minus1_xyz[k].

seq_bounding_box_size_minus1_xyz[k] plus 1 specifies a k-th component of the width, height, and depth, respectively, of coded volume dimensions in an output coordinate system. If not present, the coded volume dimensions are not defined.

seq_unit_numerator_minus1, seq_unit_denominator_minus1, and seq_unit_is_metres together specify the lengths of X, Y, and Z unit vectors in the output coordinate system.

If seq_unit_is_metres is 1, it specifies that the length of a unit vector is as follows.

$$OutputUnit = \frac{seq\_unit \_denominator \_minus1 + 1}{seq\_unit \_numerator \_minus1 + 1} metre$$

If seq_unit_is_metres is 0, it specifies that the unit vector has the following length based on an external coordinate system.

$$OutputUnit = \frac{seq\_unit \_denominator \_minus1 + 1}{seq\_unit \_numerator \_minus1 + 1} ExternalUnit$$

seq_global_scale_factor_log 2, seq_global_scale_refinement_bits, and seq_global_scale_refinement_factor together specify a fixed-point scale used to derive an output point position from a position in the coded coordinate system.

seq_global_scale_factor_log 2 is used to derive a global scale factor to be applied to positions in a point cloud.

seq_global_scale_refinement_bits is the bit length of a syntax element seq_global_scale_refinement_factor. If seq_global_scale_refinement_bits is 0, no refinement is applied.

seq_global_scale_refinement_factor specifies refinement for a global scale value. If not present, seq_global_scale_refinement_factor is inferred to be 0.

A variable GlobalScale is derived as follows.

$$globalScale D = 1 << seq\_global\_scale\_refinement\_bits$$

$$globalScale N = globalScale D + seq\_global \_scale \_refinement \_factor$$

$$seq\_global \_scale \_factor \_log2$$

$$GlobalScale = globalScale N + globalScale D$$

Variables GlobalScaleN and GlobalScaleD, used to specify constraints on point positions, are derived as follows.

$$GlobalScale D = globalScale D / Gcd ( globalScale N , globalScale D )$$

$$GlobalScale N = globalScale N / Gcd ( globalScale N , globalScale D )$$

num attributes specifies the number of attributes present in the coded point cloud.

It is a bitstream conformance requirement that all slices have an ADU or basic attribute data unit corresponding to all attributes enumerated in the SPS.

attr_comComponents_minus1[attrId] plus 1 specifies the number of components for an attrId-th attribute.

An attribute for which attr_comComponents_minus1 is greater than 2 may be coded only as raw attribute data (attr_coding_type=3).

attr_instance_id [attrId] specifies an instance identifier for the attrId-th attribute.

An attr_instance_id value is used to distinguish attributes with the same attribute label. For example, there is a point cloud having multiple color attributes sampled from various viewpoints.

$$attr\_bitlength \_minus1 [ attr Id ] + 1 specifies a bit depth for each component of the attr Id - th attribute .$$

attr_label_known [attrId], attr_label [attrId], and attr_label_oid [attrId] together identify a data type carried by the attrId-th attribute. attr_label_known [attrId] specifies whether an attribute is identified by an attr_label [attrId] value or an object identifier attr_label_oid [attrId].

Attribute types identified by attr_label are specified in the following table. Unspecified attr_label values are reserved for future use by ISO/IEC. The decoder decodes attributes with reserved values of attr_label.

TABLE 3

| attr_label | Attribute type |
|---|---|
| 0 | Colour |
| 1 | Reflectance |
| 2 | Opacity |
| 3 | Frame index |
| 4 | Frame number |
| 5 | Material identifier |
| 6 | Normal vector |

attr_property_cnt specifies the number of attribute_property syntax structures in the SPS, for the corresponding attribute.

geom_axis_order specifies the correspondence between the X, Y, and Z axes of the coded point cloud and S, T, and V axes.

An XyzToStv array defines mapping of a k-th component of (x, y, z) coordinates to an index of a coded geometric axis order (s, t, v). The value of XyzToStv[k] for k=0 . . . 2 is defined according to geom_axis_order in the following table.

TABLE 4

| | XyzToStv[k] | | |
|---|---|---|---|
| | 0 | 1 | 2 |
| geom_axis_order | (X) | (Y) | (Z) |
| 0 | 2 | 1 | 0 |
| 1 | 0 | 1 | 2 |
| 2 | 0 | 2 | 1 |
| 3 | 2 | 0 | 1 |
| 4 | 2 | 1 | 0 |
| 5 | 1 | 2 | 0 |
| 6 | 1 | 0 | 2 |
| 7 | 0 | 1 | 2 |

Output axis labels X, Y, and Z are respectively assigned to axis indexes specified by XyzToStv[k] for k=0 . . . 2 according to the following table.

TABLE 5

| Label | Axis (k) |
|---|---|
| X | XyzToStv[0] |
| Y | XyzToStv[1] |
| Z | XyzToStv[2] |

Bypass_stream_enabled specifies whether a bypass bin for an arithmetically coded syntax element is carried in a separate data stream. If it is equal to 1, two data streams are multiplexed using a fixed-length chunk sequence. If it is equal to 0, the bypass bin is encoded in the arithmetically coded data stream.

entropy_continuation_enabled specifies whether entropy parsing for a DU may depend on a final entropy parsing state of a DU in a preceding slice. When Slice_reordering_constraint is 0, it is a bitstream conformance requirement that entropy_continuation_enabled is 0.

If sps_extension present is 0, it specifies that the SPS syntax structure does not include an sps_extension_data syntax element. sps_extension present is 0 in a bitstream conforming to this document version. A value of 1 for sps_extension present is reserved for future use by ISO/IEC.

sps_extension_data may have any value. Its presence and value do not affect decoder conformance to the profiles specified in this version of this document. The decoder ignores all sps_extension_data syntax elements.

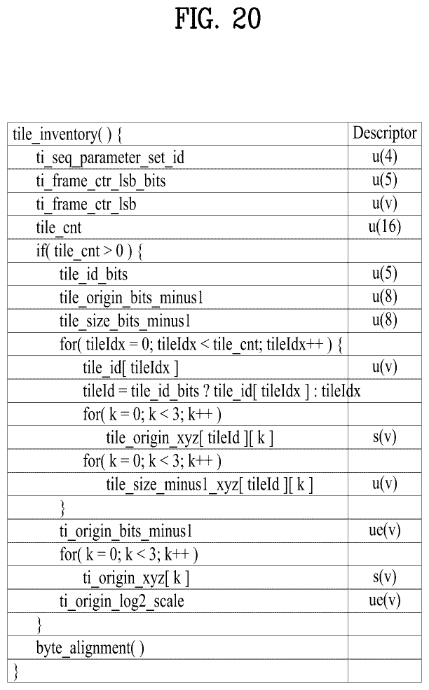

FIG. 20 illustrates a TPS or tile inventory included in a bitstream according to embodiments.

FIG. 20 illustrates the syntax of the tile inventory included in the bitstream of FIG. 18.

ti_seq parameter_set_id specifies the value of active SPS sps_seq_parameter_set_id.

ti_frame_ctr_lsb_bits specifies the length, in bits, of a ti_frame_ctr_lsb syntax element.

ti_frame_ctr_lsb specifies ti_frame_ctr_lsb_bits LSBs of FrameCtr for which the tile inventory is valid.

Tile_cnt specifies the number of tiles in the tile inventory.

Tile_id_bits specifies the length, in bits, of each Tile_id syntax element. Tile_id_bits being 0 specifies that a tile should be identified by TileIdx.

Tile_origin_bits_minus1+1 specifies the length, in bits, of each Tile_origin_xyz syntax element.

Tile_size_bits_minus1+1 specifies the length, in bits, of each Tile_size_minus1_xyz syntax element.

Tile_id [TileIdx] specifies the identifier of a Tileldx-th tile in the tile inventory. When Tile_id_bits is equal to 0, the value of Tile_id [tileldx] is inferred as Tileldx. It is a bitstream conformance requirement that all values of Tile_id should be unique within the tile inventory.

Tile_origin_xyz[TileId][k] and Tile_size_minus1_xyz[Tileld][k] represent a bounding box including a slice identified by Slice_tag identical to TileId in the coding coordinate system.

Tile_origin_xyz[TileId][k] specifies a k-th component of the origin coordinates (x, y, z) of the tile bounding box with respect to TileInventoryOrigin[k].

Tile_size_minus1_xyz[TileId][k] plus 1 specifies k-th components of the width, height, and depth of the tile bounding box, respectively.

ti_origin_bits_minus1 plus 1 is the length of each ti_origin_xyz syntax element.

ti_origin_xyz[k] and ti_origin_log 2_scale together represent the origin of the coding coordinate system specified by seq_origin_xyz[k] and seq_origin_log 2_scale. The values of ti_origin_xyz[k] and ti_origin_log 2_scale are equal to seq_origin_xyz[k] and seq_origin_log 2_scale, respectively.

The tile inventory origin is specified by a TileInventoryOrigin[k] expression.

$$TileInventoryOrigin [ k ] = ti\_origin \_xyz [ k \} << ti\_origin\_log2\_scale$$

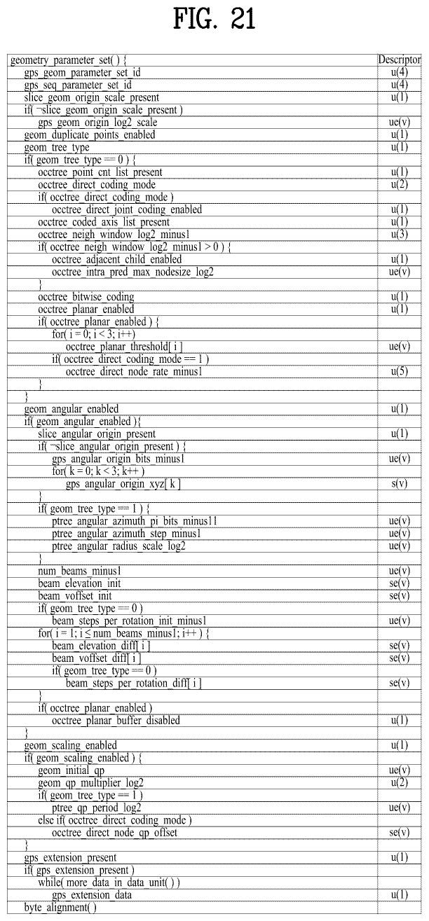

FIG. 21 illustrates a GPS included in a bitstream according to embodiments.

FIG. 21 illustrates the syntax of the GPS included in the bitstream of FIG. 18.

gps_geom_parameter_set_id identifies a GPS for reference by other DUs.

gps_seq_parameter_set_id specifies the value of active SPS

sps_seq_parameter_set_id.

Slice_geom_origin_scale_present specifies whether Slice_geom_origin_log 2_scale is present in a GDU header. If Slice_geom_origin_scale_present is 0, this specifies that a slice origin scale is equal to gps_geom_origin_log 2_scale.

gps_geom_origin_log 2_scale specifies a scaling factor for deriving a slice origin from Slice_geom_origin_xyz, when Slice_geom_origin_scale_present is 0.

geom_duplicate_points_enabled specifies whether duplicate points may be signaled in a GDU.

When geom_duplicate_points_enabled is 0, this does not prohibit encoding the same point position multiple times within a single slice.

When geom_tree_type is 0, this specifies that slice geometry is encoded using an occupancy tree. If geom_tree_type is 1, this specifies that slice geometry is encoded using a prediction tree.

occtree_point_cnt_list_present specifies whether a GDU footer enumerates the number of points at each occupancy tree level. If not present, occtree_point_cnt_list_present is inferred to be 0.

occtree_direct_coding_mode greater than 0 specifies that point positions may be encoded by eligible direct nodes of the occupancy tree. occtree_direct_coding_mode equal to 0 specifies that no direct nodes exist in the occupancy tree.

occtree_direct_joint_coding_enabled specifies whether a direct node should jointly encode the positions of two points, assuming a specific order of points.

occtree_coded_axis_list_present equal to 1 specifies that the GDU header includes an occtree_coded_axis syntax element used to derive a node size at each occupancy tree level. occtree_coded_axis_list_present equal to 0 specifies that the occtree_coded_axis syntax element is not present in the GDU syntax and that the occupancy tree represents a cubic volume.

occtree_neigh_window_log 2_minus1+1 specifies the number of occupancy tree nodes that form each window including a current node. Nodes outside the window may not be used in any process related to a node within the window. If occtree_neigh_window_log 2_minus1 is 0, it specifies that only a sibling node is considered available for the current node.

occtree_adjacent_child_enabled specifies whether an adjacent child of a neighboring occupancy tree node is used for bit occupancy contextualization. If not present, occtree_adjacent_child_enabled is inferred to be 0.

occtree_intra_pred_max_nodesize_log 2 minus 1 specifies a maximum size of an occupancy tree node eligible for occupancy intra-prediction. If not present, occtree_intra pred max_nodesize_log 2 is inferred to be 0.

occtree_bitwise_coding equal to 1 specifies that a node occupancy bitmap is encoded using a syntax element occupancy_bit. occtree_bitwise_coding equal to 0 specifies that the node occupancy bitmap is encoded using a pre-encoded syntax element occupancy_byte.

occtree_planar_enabled specifies whether the coding of the node occupancy bitmap is performed partially by signaling of a partially occupied plane and an empty plane. If not present, occtree_planar_enabled is inferred to be 0.

occtree_planar_threshold [i] specifies a threshold partially used to determine the feasibility of an axis for a planar coding mode. Thresholds are specified from maximum possible (i=0) to minimum (i=2) planar axes. Each threshold specifies a minimum likelihood for an eligible axis for which occ_single_plane[ ] is expected to be 1. The range of occtree_planar_threshold[8, 120] corresponds to a likelihood interval [0, 1).

occtree direct node_rate minus1 specifies that only occtree_direct_node_rate_minus1+1 out of 32 eligible nodes are allowed to be encoded as direct nodes.

geom_angular_enabled specifies whether the geometry is encoded using a dictionary of beam sets positioned at an angular origin and rotating around a V axis.

Slice_angular_origin present specifies whether a slice-based angular origin is signaled in the GDU header. Slice_angular_origin present equal to 0 specifies that the angular origin is gps_angular_origin_xyz. If not present, Slice_angular_origin present is inferred to be 0.

gps_angular_origin_bits_minus1+1 specifies the length, in bits, of each gps_angular_origin_xyz[k] syntax element.

gps_angular_origin_xyz[k] specifies a k-th (x, y, z) position component of the angular origin. If not present, gps_angular_origin_xyz[k] is inferred to be 0.

ptree_angular_azimuth_pi_bits_minus11 and ptree_angular_radius_scale_log 2 specify a factor used to scale the size of a position encoded using an angular coordinate system during conversion to Cartesian coordinates.

ptree_angular_azimuth_step_minus1+1 specifies a minimum change in the azimuth of a rotating beam. A differential prediction residual used in angular prediction tree coding may be expressed partially as a multiple of ptree_angular_azimuth_step_minus1+1. The value of ptree_angular_azimuth_step_minus1 is less than (1<<(ptree_angular_azimuth_pi bits_minus11+12)).

num beams minus1+1 specifies the number of beams available for an angular coding mode.

beam elevation_init and beam_elevation_diff [i] together specify a beam elevation as a gradient on an S-T plane. A per-beam elevation variation specified by a BeamElev array is a binary fixed-point value including 18 fractional bits.

BeamElev[0] = beam_elevation_init
if (num_beams_minus1 > 0)
BeamElev[1] = beam_elevation_init + beam_elevation_diff[1]
for (i = 2; i ≤ num_beams_minus1; i++)
BeamElev[i] = 2 × BeamElev[i−1] − BeamElev[i−2] +
beam_elevation_diff[i]

It is a bitstream conformance requirement that each value of BeamElev [i], for i=1 . . . num_beams_minus1, should be greater than BeamElev [i−1].

beam voffset_init and beam_voffset_diff [ i] together specify a V-axis offset from the angular origin for an i-th beam.

beam_steps per_rotation_init_minus1 and beam_steps_per_rotation_diff [i] specify the number of steps made per rotation by a rotating beam.

Arrays BeamOffsetV [i] and BeamPhiPerRev [i] for i=1 . . . num_beams_minus1 are derived as follows.

BeamOffsetV[0] = beam_voffset_init
BeamPhiPerRev[0] = beam_steps_per_rotation_init_minus1 + 1
for (i = 1; i ≤ num_beams_minus1; i++) {
BeamOffsetV[i] = BeamOffsetV[i − 1] + beam_voffset_diff[i]
BeamPhiPerRev[i] = BeamPhiPerRev[i − 1] +
beam_steps_per_rotation_diff[i]
}

It is a bitstream conformance requirement that the values of BeamPhiPerRev [i], for i=0 . . . num beams_minus1, should not be 0.

occtree_planar_buffer_disabled specifies whether the coding of an occupied planar position per node should be contextualized using the planar position of a previously coded node. If not present, occtree_planar_buffer_disabled is inferred to be 0.

geom_scaling_enabled specifies whether to scale coded geometry during a geometry decoding process. If not present, geom_scaling_enabled is inferred to be 0.

geom_initial_qp specifies a geometry position QP before adding slice-wise and node-wise offsets. If not present, geom_initial_qp is inferred to be 0.

geom_qp_multiplier_log 2 specifies a scaling factor to be applied to the coded geometry QP value. There is an 8>>geom_qp_multiplier_log 2 QP value for each doubling of a scaling step size.

ptree_qp_period_log 2 specifies the number of nodes between respective signaled predictor tree node QP offsets.

occtree_direct_node_qp_offset specifies an offset relative to a slice QP for direct node coding point position scaling. If not present, the value of occtree_direct_node_qp_offset is inferred to be 0.

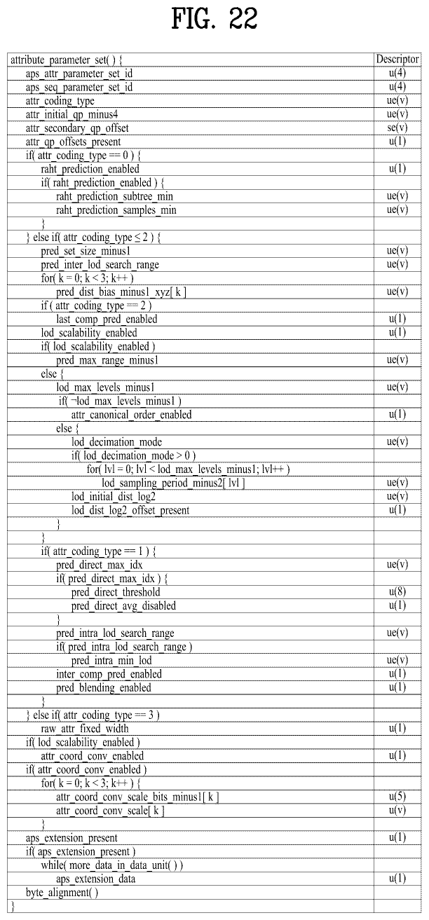

FIG. 22 illustrates an APS included in a bitstream according to embodiments.

FIG. 22 illustrates the syntax of the APS included in the bitstream of FIG. 18.

aps_attr_parameter_set_id identifies an APS for reference by other DUs.

aps_seq_parameter_set_id specifies the value of active SPS sps_seq parameter_set_id.

attr_coding_type specifies an attribute coding method as specified in Table 14. The value of attr_coding_type ranges from 0 to 3 in a bitstream conforming to this version of this document. Other values of attr_coding_type are reserved for future use by ISO/IEC.

TABLE 6

| | | Decoding |
|---|---|---|
| attr_coding_type | Description | process |
| 0 | Region Adaptive Hierarchical Transform | 10.3 |
| | (RAHT) | |
| 1 | LoD with Predicting Transform | 10.4 |
| 2 | LoD with Lifting Transform | 10.4 |
| 3 | Raw attribute data | 10.2 |

attr_initial_qp_minus4+4 specifies a QP for a primary attribute component before adding slice-wise, region-wise, and transform level-wise offsets.

attr_secondary_qp_offset specifies an offset to be applied to a primary attribute QP to derive a QP for a secondary attribute component.

attr_qp_offsets_present specifies whether a component-wise QP offset attr_qp_offset [c] is present in an ADU header.

raht prediction_enabled specifies whether to predict a RAHT coefficient from an upsampled previous transform level.

raht prediction_subtree_min and raht prediction_samples_min specify a threshold that controls the use of RAHT coefficient prediction. raht_prediction_samples_min specifies a minimum number of spatially adjacent samples for which RAHT coefficient prediction may be performed. raht_prediction_subtree_min specifies a minimum number of spatially adjacent samples that should be present to prevent RAHT coefficient prediction from being disabled for all descendents of a RAHT node.

pred_set_size_minus1+1 specifies a maximum size of a per-point predictor set.

pred_inter_lod_search_range specifies a search range used to determine a closest neighbor for inter-level of detail prediction.

pred_dist_bias_minus1_xyz[k]+1 specifies a factor used to weight a k-th XYZ component of a distance vector between two point positions used to calculate an inter-point distance in predictor searches for a single materialized point.

A PredBiasStv array with values PredBiasStv [k], for k=0 . . . 2, represents pred_dist_bias_minus1_xyz values permuted in a coded geometry axis order as follows.

$$PredBiasStv [ Xyz To Stv [ k ] ] = pred\_dist \_bias \_minus1 \_xyz [ k ] + 1$$

last_comp_pred_enabled specifies whether to use a second coefficient component of a three-component attribute to predict the value of a third coefficient component. If last_comp_pred_enabled is not present, it is inferred to be 0.

lod_scalability_enabled specifies whether to enable scalable attribute coding. When enabled, attribute values may be reconstructed for partially decoded slice geometry.

It is a bitstream conformance requirement that lod_scalability_enabled should be equal to 0, when one of the following conditions is true: geom_tree_type is equal to 1, or occtree_coded_axis_list_present is equal to 1, or geom_qp_multiplier_log 2 is not 3, or pred_blending_enabled is equal to 1.

If pred_max_range_minus1+1 is present, it specifies a distance at which a point prediction candidate should be discarded during predictor set pruning. The distance is specified in units of a level of detail block size.

lod max levels_minus1+1 specifies a maximum number of levels of detail that may be generated in a LoD generation process. If not present, MaxSliceDimLog2 is inferred to be 1.

attr_canonical_order_enabled specifies whether an order in which point attributes are encoded is the same as an order in which points are output by the geometry decoding process specified in this document.

lod decimation_mode specifies a decimation method used to generate levels of detail as specified in the following table.

TABLE 7

| lod_decimation_mode | Description | Decoding process |
|---|---|---|
| 0 | No decimation | 10.4.4.6 |
| 1 | Periodic subsampling | 10.4.4.5 |
| 2 | Block based subsampling | 10.4.4.8 |
| ≥3 | Reserved | — |

lod_sampling_period_minus2 [1v1]+2 specifies a sampling period used for sampling points of level of detail 1v1 to generate a next coarser level of detail 1v1+1 in LoD generation.

lod_initial_dist_log 2 specifies a finest level of detail block size used for LoD generation and predictor searching. If not present, lod_initial_dist_log 2 is inferred to be 0.

lod_dist_log 2_offset present specifies whether to calculate a finest level of detail block size using a per-slice block size offset specified by lod_dist_log 2_offset. If not present, lod_dist_log 2_offset_present is inferred to be 0.

pred_direct_max_idx specifies a maximum number of single-point predictors that may be used for direct prediction.

pred_direct_threshold specifies a minimum difference between point prediction values before a point is eligible for direct prediction. If an attribute bit depth is greater than 8 bits, pred_direct_threshold is scaled by 1<<AttrBitDepth-8 to determine the minimum difference.

pred_direct_avg_disabled specifies whether neighbor average prediction is available for a direct prediction mode.

pred_intra_lod_search_range specifies a maximum number of candidate points within a level of detail used to select a predictor set for each point.

pred_intra_min_lod specifies a finest level of detail for which intra-level of detail prediction is enabled. If not present, pred_intra_min_lod is inferred to be lod max levels minus1+1. It is a bitstream conformance requirement that pred_intra_min_lod is equal to 0, when lod_max levels minus1 is 0.

inter_comp_pred_enabled specifies whether to use a first component of a multi-component attribute coefficient to predict the value of a subsequent component. If inter_comp_pred_enabled is not present, it is inferred to be 0.

pred_blending_enabled specifies whether to blend neighbor weights used for neighbor average prediction according to the relative spatial positions of associated points. If not present, pred_blending_enabled is inferred to be 0.

raw_attr_fixed_width specifies whether the coding of a raw attribute value should use fixed-length (when equal to 1) or variable-length coding (when equal to 0).

attr_coord_conv_enabled specifies whether attribute coding should use scaled angular coordinates (when equal to 1) or coded point positions (when equal to 0). If geom_angular_enabled is 0, then attr_coord_conv_enabled should be 0. If attr_coord_conv_enabled is not present, its value is inferred to be 0.

attr_coord_conv_scale_bits_minus1 [k]+1 specifies the length, in bits, of each attr_coord_conv_scale [k] syntax element.

attr_coord_conv_scale [k] specifies a scale factor used to scale a k-th angular coordinate component of a point position for use in attribute coding.

A frame boundary marker included in the bitstream explicitly marks the end of a current frame.

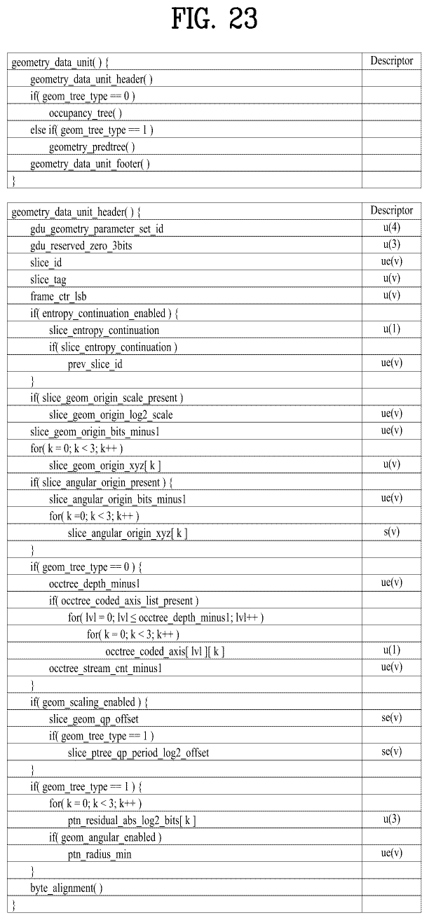

FIG. 23 illustrates a geometry data unit and a geometry data unit header included in a bitstream according to embodiments.

FIG. 23 illustrates the syntax of the geometry data unit and header included in the bitstream of FIG. 18.

gdu geometry parameter_set_id specifies the value of active GPS gps_geom_parameter_set_id.

Slice_id identifies a slice for reference by other syntax elements.

Slice_tag may be used to identify one or more slices with a particular Slice_tag value. If a tile inventory data unit is present, Slice_tag is a tile ID. Otherwise, if no tile inventory data unit is present, the interpretation of Slice_tag is specified by external means.

Frame_ctr_lsb specifies frame_ctr_lsb_bits LSBs of a conceptual frame number counter. Consecutive slices with different Frame_ctr_lsb values form parts of different output point cloud frames. Consecutive slices with the same frame_ctr lsb value and without a frame boundary marker data unit in between form a part of the same coded point cloud frame.

Slice_entropy_continuation equal to 1 specifies that an entropy parsing state restoration process (11.8.2.2 and 11.8.3.2) should be applied at the start of the GDU and all ADUs of the slice. Slice_entropy_continuation equal to 0 specifies that entropy parsing of the GDU and all ADUs of the slice are independent of other slices. If not present, Slice_entropy_continuation is inferred to be 0. It is a bitstream conformance requirement that Slice_entropy_continuation is equal to 0, when the GDU is the first DU of the coded point cloud frame.

prev_slice_id is equal to the value of Slice_id of the previous GDU in a bitstream order. The decoder ignores a slice for which all prev_slice_id values are present and which is not equal to the Slice_id value of the previous slice.

Slice_geom_origin_log 2_scale specifies a scaling factor for a slice origin. If not present, Slice_geom_origin_log 2_scale is inferred to be gps_geom_origin_log 2_scale.

Slice_geom_origin_bits_minus1+1 specifies the length, in bits, of each syntax element Slice_geom_origin_xyz[k].

Slice_geom_origin_xyz[k] specifies a k-th component of the quantized (x, y, z) coordinates of the slice origin.

A SliceOriginStv array with values SliceOriginStv [k], for k=0 . . . 2, represents scaled values of Slice_geom_origin_xyz permuted in the coded geometry axis order as follows.

$$SliceOrigin Stv [ Xyz To Stv [ k ] ] = Slice\_geom \_origin \_xyz [ k ] << Slice\_geom\_origin\_\_log2\_scale$$

Slice_angular_origin_bits_minus1+1 specifies the length, in bits, of each Slice_angular_origin_xyz[k] syntax element.

Slice_angular_origin_xyz[k] specifies a k-th component of the (x, y, z) coordinates of the origin used for angular coding mode processing. If not present, Slice_angular_origin_xyz[k] is inferred to be 0.

A GeomAngularOrigin array with GeomAngularOrigin[k] values for k=0 . . . 2 represents slice-relative angular origins permuted in the coded geometry axis order as follows.

for (k = 0; k < 3; k++)
if (slice_angular_origin_present)
GeomAngularOrigin[XyzToStv[k]] = slice_angular_origin_xyz[k]
else
GeomAngularOrigin[XyzToStv[k]] =
gps_angular_origin_xyz[k] − SliceOriginStv[XyzToStv[k]]

occtree_length_minus1+1 specifies a maximum number of tree levels present in the coded octree. If occtree_coded_axis list_present is 0, a root node size is a cubic volume with an edge length equal to Exp2 (occtree_length_minus1+1).

occtree_coded_axis [dpth][ ] specifies whether subdivision along an STV axis is coded (if 1) or not coded (if 0) for tree nodes at a depth, dpth. occtree_coded_axis is used to determine a node volume size at each level of the octree. If occtree_coded_axis [dpth][ ] is not present, it is inferred to be 1.

Bitstream conformance requirements are given as follows.

All tree levels specified by occtree_coded_axis have at least one coded axis. That is, Max Vec (occtree_coded_axis [dpth])==1.

The log 2 dimensions of the root node are less than or equal to MaxSliceDimLog2.

The largest log 2 dimension of the root node is greater than occtree_length_minus1-4.

occtree_stream_cnt_minus1+1 specifies a maximum number of entropy streams used to encode the octree. If occtree_stream_cnt_minus1 is greater than 0, each of bottom occtree stream_cnt minus1 tree levels is carried in a separate entropy stream. A parsing state is remembered and restored according to 11.6.

An OcctreeEntropyStreamDepth expression is the depth of a last tree level encoded in a first entropy stream.

OcctreeEntropy StreamDepth: =occtree_depth_minus1-occtree_stream_cnt_minus 1 occtree_end_of_entropy_stream is an uncoded syntax element used to specify a termination point for an arithmetic decoder at the end of an entropy stream.

occtree 1v1 point_cnt_minus1 [dpth]+1 indicates the number of points that may be partially decoded (see Annex D) from the root node up to the end of the tree level of the depth, dpth. occtree_1v1_point_cnt_minus1 [0] is inferred to be 0.

occtree_1v1_point_cnt_minus1 [occtree length_minus1] is inferred to be Slice_num points_minus1.

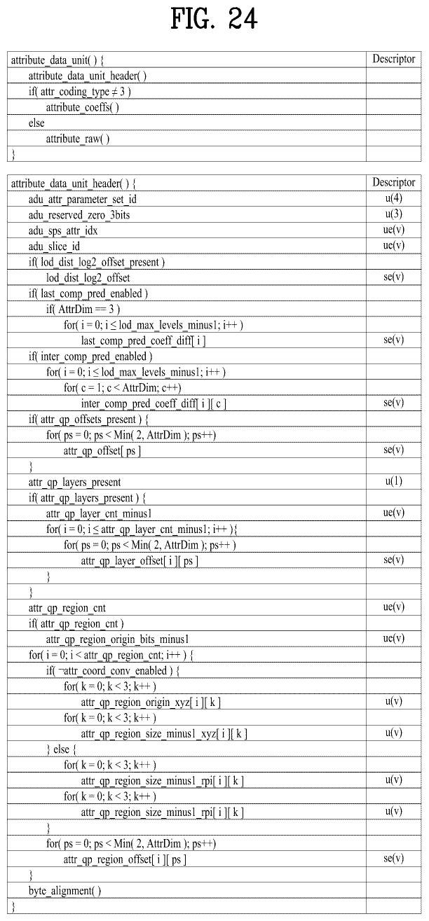

FIG. 24 illustrates an attribute data unit and an attribute data unit header included in a bitstream according to embodiments.

FIG. 24 shows the syntax of the attribute data unit and header included in the bitstream of FIG. 18.

adu_attr_parameter_set_id specifies the value of active APS

aps_attr_parameter_set_id.

adu_sps_attr_idx identifies an attribute encoded as an index into an active SPS attribute list. Its value is in the range of 0 . . . num_attributes−1.

Attributes encoded by an ADU have at most 3 components, when attr_coding_type is not 3.

$$Attr Id x = adu\_sps \_attr \_idx$$

$$AttrDim = attr\_components \_minus1 [ adu\_sps \_attr \_idx ] + 1$$

$$AttrBitDepth = attr\_bitdepth \_minus1 [ adu\_sps \_attr \_idx ] + 1$$

$$Attr MaxVal = ( 1 << Attr BitDepth ) - 1$$

adu_slice_id specifies the value of a previous GDU Slice_id.

lod_dist_log 2_offset specifies an offset used to derive an initial slice subsampling factor used for level of detail generation. If not present, lod_dist_log 2_offset is inferred to be 0.

last_comp_pred_coeff_diff [i] specifies a delta scaling value for the last component predicted value at an i-th level of detail from the second component of a multi-component attribute. If last_comp_pred_coeff_diff [i] is not present, it is inferred to be 0.

A LastCompPredCoeff array with LastCompPredCoeff [i] elements for i=0 . . . lod_max levels minus1 is derived as follows.

initCoeff = last_comp_pred_enabled << 2
for (i = 0; i ≤ lod_max_levels_minus1; i++) {
predCoeff = !i ? initCoeff : LastCompPredCoeff[i − 1]
LastCompPredCoeff[i] = predCoeff + last_comp_pred_coeff_diff[i]
}

The values of LastCompPredCoeff [i] for all i are in the range of −128 . . . 127. inter_comp_pred_coeff_diff [i][c] specifies a k-th delta scaling value for the predicted value of a non-primary component at an i-th level of detail from a primary component of a multi-component attribute. If inter_comp_pred_coeff_diff [i][c] is not present, it is inferred to be 0.

An InterCompPredCoeff array with InterCompPredCoeff [i][c] elements for i=0 . . . lod max levels minus1 and c=1 . . . . AttrDim−1 is derived as follows.

initCoeff = inter_comp_pred_enabled << 2
for (i = 0; i ≤ lod_max_levels_minus1; i++)
for (c = 1; c < AttrDim; c++) {
predCoeff = !i ? initCoeff : InterCompPredCoeff[i − 1][c]
InterCompPredCoeff[i][c] = predCoeff +
inter_comp_pred_coeff_diff[i][c]
}

The values of InterCompPredCoeff [i] for all i are in the range of −128. 127.

attr_qp_offset [ps] specifies a slice offset used to derive QPs for primary (ps=0) and secondary (ps=1) attribute components. If not present, the value of attr_qp_offset [ps] is inferred to be 0.

attr_qp_layers_present equal to 1 specifies that layer-wise QP offsets are present in a current DU. attr_qp_layers_present equal to 0 specifies that no such offsets are present.

attr_qp_layer_cnt_minus1+1 specifies the number of layers for which QP offsets are signaled. If attr_qp_layer_cnt_minus1 is not present, the value of attr_qp_layer_cnt_minus1 is inferred to be 0.

attr_qp_layer_offset [layer][ps] specifies a layer offset used to derive QPs for the primary (ps=0) and secondary (ps=1) attribute components. If not present, the value of attr_qp_layer_offset [layer][ps] is inferred to be 0.

Expressions AttrQpP [layer] and AttrQpOffsetS [layer] specify a QP for the primary attribute component and a QP offset for the secondary attribute component, respectively, before adding region-based QP offsets.

$$AttrQpP [ layer ] := attr\_initial \_qp \_minus4 + 4 + attr\_qp \_offset [ 0 ] + attr\_qp \_layer \_offset [ layer ] [ 0 ]$$

$$AttrQp Offset S [ layer ] := attr\_secondary \_qp \_offset + attr\_qp \_offset [ 1 ] + attr\_qp \_layer \_offset [ layer ] [ 1 ]$$

attr_qp_region_cnt specifies the number of spatial regions within a current slice for which region QP offsets are signaled.

attr_qp_region_origin_bits_minus1+1 specifies the bit length of each syntax element attr_qp_region_origin_xyz and attr_qp_region_size_minus1_xyz.

attr_qp_region_origin_xyz[i][k] and attr_qp_region_size_minus1_xyz[i][k] specify an i-th spatial region of a slice to which attr_qp_region_offset [i][c] applies. The region is a bounding box in the slice coordinate system with lower XYZ coordinates attr_qp_region_origin_xyz[i][k] and dimensions attr_qp_region_size_minus1_xyz[i][k]+1, for k=0 . . . 3.

AttrRegionQpOriginStv and AttrRegionQpSizeStv arrays with values

AttrRegionQpOriginStv [i][k] and AttrRegionQpSizeStv [i][k] for i=0 . . . attr_qp_region_cnt
1 and k=0 . . . 2 represent a region origin and size, respectively, permuted in the coded geometry axis order as follows.

if (!enabled) {
AttrRegionQpOriginStv[i][XyzToStv[k]] =
attr_qp_region_origin_xyz[i][k]
AttrRegionQpSizeStv[i][XyzToStv[k]] =
attr_qp_region_size_minus1_xyz[i][k] + 1
}

attr_qp_region_origin_rpi [i][k] and attr_qp_region_size_minus1_rpi[i][k] specify an i-th spatial region of a slice to which attr_qp_region_offset [i][c] applies. The region is a bounding box in a scaled angular coordinate system used for attribute coding with lower radius-azimuth-beam coordinates attr_qp_region_origin_rpi [i][k] and dimensions attr_qp_region_size_minus1_rpi [i][k]+1, for k=0 . . . 3.

if (attr_coord_conv_enabled) {
AttrRegionQpOriginStv[i][k] = attr_qp_region_origin_rpi[i][k]
AttrRegionQpSizeStv[i][k] = attr_qp_region_size_minus1_rpi[i][k] + 1
}

It is a bitstream conformance requirement that the following condition is true for k=0 . . . 2.

$$Attr Region Qp Origin Stv [ i ] [ k ] + Attr Region Qp Size Stv [ i ] [ k ] < ( 1 << MaxSliceDimLog2 )$$

attr_qp_region_offset [i][ps] specifies an offset used to derive QPs for primary (ps=0) and secondary (ps=1) attribute components of points located within a region defined by AttrRegionQpOriginStv [i] and AttrRegionQpSizeStv [i] If not present, attr_qp_region_offset [i][ps] is inferred to be 0.

Regarding the G-PCC system, this describes the encapsulation of G-PCC bitstreams in tracks of a file. A G-PCC bitstream is configured as a TLV encapsulation structure carrying parameter sets, coded geometry bitstreams, and zero or more coded attribute bitstreams. This G-PCC bitstream is stored in a single track or multiple tracks.

Regarding a volumetric visual track, the volumetric visual track is identified by a volumetric visual media handler type ‘volv’ in HandlerBox of MediaBox and a volumetric visual media header. A file may have multiple volumetric visual tracks.

The composition of a volumetric visual media header is as follows:
Box Type: ‘vvhd’
Container: MediaInformationBox
Mandatory: Yes
Quantity: Exactly one

The volumetric c visual track uses Volumetric VisualMediaHeaderBox in MediaInformationBox.

aligned(8) class VolumetricVisualMediaHeaderBox
extends FullBox(‘vvhd’, version = 0, 1) {
}

version is an integer value specifying the version of this box.

The composition of a volumetric visual sample entry is as follows.

A volumetric visual track uses VolumetricVisualSampleEntry.
class VolumetricVisualSampleEntry(codingname)
extends SampleEntry (codingname){
unsigned int(8)[32] compressorname;
/ other boxes from derived specifications
}

compressorname is an informational name. It is formatted as a fixed 32-byte field, where the first byte is set to the number of bytes to be represented, followed by the bytes of displayable data encoded using UTF-8, and then padded to fill a total of 32 bytes.

The composition of volumetric visual samples is defined by the coding system.

A common data structure included in the tracks of the file is described.

Regarding a G-PCC decoder configuration box, the G-PCC decoder configuration box includes GPCCDecoderConfigurationRecord( ).

class GPCCConfigurationBox extends Box(‘gpcC’) {
GPCCDecoderConfigurationRecord( ) GPCCConfig;
}

The G-PCC decoder configuration record specifies G-PCC decoder configuration information for geometry-based point cloud content. This G-PCC decoder configuration record includes a version field. Incompatible changes to the record are indicated by a change in the version number. If the version number is not recognized, a reader should not attempt to decode this record or a stream to which it applies. Compatible extensions to this record extend it and do not change the configuration version code.

The values of profile_idc, profile_compatibility_flags, and level idc are valid for all parameter sets (hereinafter, referred to as “all parameter sets” in the next sentence of this paragraph) that are active when a stream described in this record is decoded. In particular, the following restrictions apply.

A profile indication profile_idc indicates a profile that the stream associated with this configuration record conforms to.

Each bit of profile_compatibility_flags may be set only if all parameter sets have that bit set.

A level indication level_idc indicates a capability level equal to or higher than a highest level indicated for a highest tier among all parameter sets.

A setupUnit array includes a G-PCC TLV encapsulation structure that is constant for a stream referenced by a sample entry in which the decoder configuration record is present. The type of the G-PCC encapsulation structure is limited to indicate an SPS, a GPS, an APS, and a TPS.

aligned(8) class GPCCDecoderConfigurationRecord {
unsigned int(8)configurationVersion = 1;
unsigned int(1)simple_profile_compatibility_flag;
unsigned int(1)dense_profile_compatibility_flag;
unsigned int(1)predictive_profile_compatibility_flag;
unsigned int(1)main_profile_compatibility_flag;
unsigned int(18)reserved_profile_compatibility_18bits;
unsigned int(8)level_idc;
unsigned int(8)numOfSetupUnits;
for (i=0; i<numOfSetupUnits; i++) {
tlv_encapsulationsetupUnit; /as defined in ISO/IEC 23090-9
}
/ additional fields
}

Configuration Version is a version field. Incompatible changes to the record are indicated by a change in a version number.

simple_profile_compatibility_flag being 1 specifies that the bitstream conforms to the simple profile defined in Annex A of ISO/IEC 23090-9 [GPCC].

simple_profile_compatibility_flag being 0 specifies that the bitstream conforms to a profile other than the simple profile.

density_profile_compatibility_flag being 1 specifies that the bitstream conforms to the dense profile defined in Annex A of ISO/IEC 23090-9 [GPCC].

Dense_profile_compatibility_flag being 0 specifies that the bitstream conforms to a profile other than the dense profile.

Predictive_profile_compatibility_flag being 1 specifies that the bitstream conforms to the predictive profile defined in Annex A of ISO/IEC 23090-9 [GPCC].

Predictive_profile_compatibility_flag being 0 specifies that the bitstream conforms to a profile other than the predictive profile.

main_profile_compatibility_flag being 1 specifies that the bitstream conforms to the main profile defined in Annex A of ISO/IEC 23090-9 [GPCC]. main_profile_compatibility_flag being 0 specifies that the bitstream conforms to a profile other than the main profile.

numOfSetupUnits specifies the number of G-PCC setup units in the decoder configuration record.

setupUnit includes one G-PCC device carrying one of an SPS, a GPS, an APS, and a tile inventory as defined in ISO/IEC 23090-9 [GPCC].

The composition of a G-PCC component information box is as follows.
Box Type: ‘ginf’
Container: Sample Entry (‘gpcl’, ‘gpcg’, or ‘gptl’)
Mandatory: No
Quantity: Zero or one may be present

This box indicates the type of a G-PCC component such as geometry and attribute. If this box is present in a sample entry of a track, it indicates the type of a G-PCC component included in that track. This box also provides an attribute name, index, and optional attribute type or international object identifier label for a G-PCC attribute component carried by each G-PCC attribute track.

The flag value of this box indicates the presence or absence of attribute type information and how the attribute type is indicated if the attribute type information is present, as follows.

TABLE 8

| flags value | Description |
|---|---|
| 0x000000 | No attribute type information presents |
| 0x000001 | The attribute type information presents, and the attribute |
| | type is indicated by the value of attr_label_oid. |
| 0x000002 | Reserved |
| 0x000003 | The attribute type information presents, and the |
| | attribute type is indicated by the value of attr_type. |
| 0x00004 . . . | Reserved. |
| 0xFFFFFF | |

aligned(8) class GPCCComponentInfoBox
extends FullBox(‘ginf’, 0, flags) {
unsigned int(8)gpcc_type;
if(gpcc_type == 4) {
unsigned int(8)attr_index;
if (flags == 0x000001) {
unsigned int(8)attr_type;
} else if (flags == 0x000003) {
oidattr_label_oid;
}
utf8stringattr_name;
}
}

gpcc_type identifies the type of a G-PCC component as specified in the following table.

TABLE 9

| gpcc_type value | Description |
|---|---|
| 1 | Reserved |
| 2 | Geometry Data |
| 3 | Reserved |
| 4 | Attribute Data |
| 5 . . . 31 | Reserved. |

attr index identifies the order of attributes indicated in the SPS.

attr_type identifies the type of an attribute component as specified in Table 9 of ISO/IEC 23090-9 [GPCC].

For attr_label_oid, refer to ITU-T Recommendation X.660|ISO/IEC 9834-1. The syntax of Object Identifier is described in subclause 11.4.7.1 of ISO/IEC 23090-9 [GPCC].

attr_name specifies a human-readable name for a G-PCC attribute component type.

The composition of a sample group included in the track of the file is as follows.
Group Types: ‘sgld’
Container: Sample Group Description Box (‘sgpd’)
Mandatory: No
Quantity: Zero or more

The use of ‘sgld’ for grouping_type in sample grouping indicates the level of detail of samples in a G-PCC geometry track.

The syntax of the sample group is as follows.

aligned(8) class LevelOfDetailInfoEntry( )
extends VolumetricVisualSampleGroupEntry (‘sgld’){
unsigned int(32) max_num_lod;
unsigned int(1) initial_lod_enabled_flag;
unsigned int(1) suggested_lod_enabled_flag;
bit(6) reserved = 0;
if(initial_lod_enabled_flag)
unsigned int(32) initial_lod;
if(suggested_lod_enabled_flag)
unsigned int(32) suggested_lod;
}

The semantics of the sample group are as follows. max num lod indicates a maximum number of occupancy tree levels present in a G-PCC sample as defined in ISO/IEC 23090-9. initial_lod_enabled_flag indicates whether an initial level of detail is signaled.

suggested_lod_enabled_flag indicates whether a suggested level of detail is signaled.

initial lod indicates an initial level or default value of an occupancy tree present in a G-PCC sample within the maximum number of occupancy tree levels defined in ISO/IEC 23090-9. That is, initial_lod indicates to the receiver (decoder) the initial level of the occupancy tree that should be initially decoded, when decoding samples of the sample group.

suggested_lod indicates a suggested or recommended level of the occupancy tree present in the G-PCC sample within the maximum number of levels of the occupancy tree defined in ISO/IEC 23090-9. That is, suggested_lod may signal a specific level of the occupancy tree that the encoder intends or suggests for decoding, when decoding samples of the sample group or when generating point cloud frames.

The behavior of the decoder (receiver) via initial_lod (first LoD), suggested_lod (second LoD), and flags for the first and second LoD is as follows.

Both initial lod_enabled_flag and suggested_lod_enabled_flag values may be false. In this case, the receiver may only know the max_num lod value.

If both initial_lod_enabled_flag and suggested_lod_enabled_flag values are true, the receiver may decode the corresponding frame by setting the initial lod value as a minimum requirement and the suggested_lod value as a maximum requirement. That is, initial_lod may mean a minimum LoD value that the receiver should decode, and suggested_lod may mean a maximum LoD value that should be decoded, if the specifications and resources of the receiver allow.

If initial_lod_enabled_flag is true and suggested_lod_enabled_flag is false, the receiver may decode a sample belonging to the corresponding sample group, that is, a frame, by setting the initial_lod value as the minimum requirement. In this case, this may mean that the receiver may also decode at an LoD equal to or greater than initial lod.

If initial_lod_enabled_flag is false and suggested_lod_enabled flag is true, the receiver may decode the samples belonging to the corresponding sample group, that is, the frame, by applying the suggested_lod value. In this case, the receiver may also decode with a value less than or greater than the suggested_lod value. However, if decoding is performed with a value less than the suggested_lod value, the frame that should be displayed finely from a rendering perspective intended by a content creator may be displayed coarsely. Further, if decoding is performed with a value greater than or equal to the suggested_lod value, the frame that should be displayed coarsely from a rendering perspective intended by the content creator may be displayed finely, and the receiver uses more resources, which may lead to an unnecessary operation.

At least one track of a file may be grouped together.

FIG. 25 illustrates the structure of a sample, when a coded G-PCC bitstream is stored in a single track according to embodiments.

G-PCC data encapsulation based on ISOBMFF is as follows:

When a G-PCC bitstream is delivered in a single track, a G-PCC encoded bitstream is indicated by a single track declaration. Single-track encapsulation of G-PCC data may leverage simple ISOBMFF encapsulation by storing the G-PCC bitstream in a single track without additional processing.

Each sample in this track includes one or more G-PCC components. That is, each sample is configured as one or more TLV encapsulation structures. FIG. 25 illustrates an example of a sample structure, when G-PCC geometry and attribute bitstreams are stored in a single track.

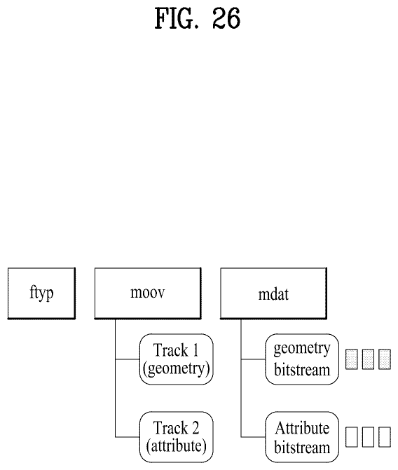

FIG. 26 illustrates a multi-track container of a G-PCC bitstream according to embodiments.

When an encoded G-PCC geometry bitstream and an encoded G-PCC attribute bitstream are stored in separate tracks, each sample of a track includes at least one TLV encapsulation structure carrying single G-PCC component data, not both geometry and attribute data. FIG. 26 illustrates a typical layout in this case.

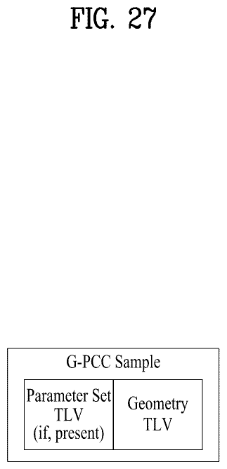

FIG. 27 illustrates the structure of a sample in a track carrying only a G-PCC geometry bitstream according to embodiments.

The G-PCC geometry bitstream must be decoded first, and the decoding of the G-PCC attribute bitstream depends on the decoded geometry. Accordingly, storing different G-PCC component bitstreams in separate tracks allows a player to access the track carrying the geometry bitstream before the attribute bitstream. FIG. 27 shows an example of the sample structure of a track carrying only the encoded G-PCC geometry bitstream.

The file structure of a G-PCC system follows following features:
a) When the G-PCC bitstream is carried in multiple tracks, the track carrying the G-PCC geometry bitstream serves as an entry point.
b) A new box (information) is added to the sample entry to indicate the role of the stream contained in this track.
c) A track reference is introduced from the track carrying only the G-PCC geometry bitstream to the track carrying the G-PCC attribute bitstream.

The sample entry has the following elements:
Sample Entry Type: ‘gpel’, ‘gpeg’, ‘gpcl’ or ‘gpcg’
Container: SampleDescriptionBox
Mandatory: A ‘gpel’, ‘gpeg’, ‘gpcl’ or ‘gpcg’ sample entry is mandatory
Quantity: One or more sample entries may be present

A G-PCC track uses Volumetric VisualSampleEntry whose sample entry type is ‘gpel’, ‘gpeg’, ‘gpcl’, or ‘gpcg’.

A G-PCC sample entry includes GPCCConfigurationBox and optionally GPCCComponentTypeBox.

All parameter sets (as defined in ISO/IEC 23090-9 [GPCC]) under a ‘gpel’ sample entry are present in the setupUnit array. The parameter set under a ‘gpeg’ sample entry may be present in this array or in the stream. GPCCComponentTypeBox is not present under the ‘gpel’ or ‘gpeg’ sample entry.

In a ‘gpcl’ sample entry, the SPS, GPS, and tile inventory (as defined in ISO/IEC 23090-9 [GPCC]) are present in the setupUnit array of the track carrying the G-PCC geometry bitstream. Any associated APS is present in the setupUnit array of the track carrying the G-PCC attribute bitstream. In a ‘gpcg’ sample entry, the SPS, GPS, APS, or tile inventories may be present in this array or a stream. GPCCComponentTypeBox is present under the ‘gpcl’ or ‘gpcg’ sample entry.

When multiple parameter sets are used and parameter set updates are required, the parameter sets may be included in the stream sample.

aligned(8) class GPCCSampleEntry( )
extends VolumetricVisualSampleEntry (codingname) {
GPCCConfigurationBox config; /mandatory
GPCCComponentTypeBoxtype; / optional
}

The compressorname of the base class Volumetric VisualSampleEntry indicates the compressor name used along with the recommended value “/013GPCC Coding”. The first byte represents the count of the remaining bytes. Here, it is indicated as /013 (octal 13), which corresponds to 11 (decimal), the number of bytes of the remaining string.

The config contains the G-PCC decoder configuration record information.

“type” indicates the type of G-PCC component carried in each track.

The sample format is as follows:

Each G-PCC bitstream sample corresponds to a single point cloud frame and consists of one or more TLV encapsulation structures belonging to the same presentation time. Each TLV encapsulation structure contains a single type of G-PCC payload (e.g., geometry slice, attribute slice). Samples may be independent (e.g., sync samples).

aligned(8) class GPCCSample
{
unsigned int GPCCLength = sample_size; //Size of Sample
for (i=0; i< GPCCLength; ) / to end of the sample
{
tlv_encapsulation gpcc_unit;
i += (1+4)+ gpcc_unit.tlv_num_payload_bytes;
}
}

gpcc_unit contains an instance of a G-PCC TLV encapsulation structure including a single G-PCC data unit.

Sub-samples are now described below:

To use SubSampleInformationBox in a G-PCC bitstream, sub-samples are defined based on the value of a flag field in the sub-sample information box. The flag specifies the type of sub-sample information provided in this box as follows:
0: G-PCC TLV encapsulation structure-based sub-sample. A sub-sample contains only one G-PCC TLV encapsulation structure as defined in ISO/IEC 23090-9 [GPCC].
1: Tile-based sub-sample. A sub-sample contains one or more consecutive TLV encapsulation structures corresponding to one G-PCC tile, or one or more consecutive TLV encapsulation structures containing each parameter set, tile list, or frame boundary marker.
Other values of the flag are reserved.

When the G-PCC geometry bitstream and G-PCC attribute bitstream are carried in the same track, exactly one SubSampleInformationBox with a flag equal to 0 or 1 is present in the SampleTableBox or in the TrackFragmentBox of each MovieFragmentBox.

When SubSampleInformationBox with a flag equal to 0 is present, the 8-bit type value of the TLV encapsulation structure and, if the TLV encapsulation structure contains an attribute data unit, the 6-bit value of the attribute index, are included in the 32-bit codec_specific parameters field of the sub-sample entry in the SubSampleInformationBox. The type of each sub-sample is identified by parsing the codec_specific_parameters field of the sub-sample entry in the SubSampleInformationBox.

The codec_specific_parameters field in the SubSampleInformationBox is defined as follows:

if (flags == 0) {
unsigned int(8) payloadType;
if (PayloadType == 4) { / attribute payload
unsigned int(6) attrIdx;
bit(18) reserved = 0;
}
else
bit(24) reserved = 0;
} else if (flags == 1) {
unsigned int(1) tile_data;
bit(7) reserved = 0;
if (tile_data)
unsigned int(24) tile_id;
else
bit(24) reserved = 0;
}

payloadType indicates the tlv_type in the TLV encapsulation structure of the sub-sample.

attrIdx indicates the ash attr sps attr_idx in the TLV encapsulation structure containing the attribute data unit of the sub-sample.

Tile data indicates whether the sub-sample includes a single tile or includes other tiles. Tile_data equal to 1 indicates that the sub-sample contains a TLV encapsulation structure that includes a geometry data unit or attribute data unit corresponding to a single G-PCC tile. Tile_data equal to 0 indicates that the sub-sample includes a TLV encapsulation structure that includes each parameter set, tile list, or frame boundary marker.

Tile_id indicates the index of the G-PCC tile to which the sub-sample is connected within the tile inventory.

For inter-track referencing of G-PCC tracks, the following method is applied:

When a G-PCC bitstream is transmitted in multiple tracks, a track reference tool is used to connect the tracks. One TrackReferenceTypeBoxes is added to the TrackReferenceBox in the TrackBox of a G-PCC track. The TrackReferenceTypeBox includes a track_ID array specifying a track referenced by the G-PCC track.

A G-PCC system file may include a timed metadata track.

In addition to the above-described sample grouping method, a separate timed metadata track may be configured to signal level of detail information that may dynamically change over time.

Methods/devices according to embodiments may be configured to store non-timed G-PCC data in the ISOBMFF format through the G-PCC system file and deliver the same (Non-timed G-PCC data storage in ISOBMFF).

Image items according to embodiments are described below:

For G-PCC items of an image item, an item of type ‘gpel’ is composed of G-PCC units of the G-PCC bitstream, and the bitstream contains a single G-PCC frame. This item is associated with one GPCConfigurationProperty.

When non-timed G-PCC data is stored in multiple items per G-PCC component (i.e., the G-PCC component is encapsulated in multiple items), an item of type ‘gpcl’ may be used. When G-PCC data is carried in multiple items using the item type ‘gpcl’ (i.e., a G-PCC component is stored and delivered in multiple items), the item delivering the G-PCC geometry component may serve as the entry point. Items containing G-PCC attribute components may be presented as hidden items. In other words, presenting as a hidden item may indicate that the item containing the G-PCC attribute component cannot be decoded independently. A new item reference type including the 4CC code ‘gpca’ may be used from an item containing only the G-PCC geometry component to an item containing the G-PCC attribute component.

When non-timed G-PCC data includes multiple G-PCC tiles and each of the G-PCC tiles is represented as a separate G-PCC tile item, an item of type ‘gpeb’ is used. The ‘gpeb’ item is connected to GPCConfigurationProperty. This item does not include geometry or attribute data units. This item does not include geometry or attribute data units. When this item is present, one or more G-PCC tile items are present. To indicate the relationship between a ‘gpeb’ item and a G-PCC tile item, a new item reference type including the 4CC code ‘gpbt’ is used. This item reference is defined from a G-PCC item to a related G-PCC tile item.

When PrimaryItemBox is present, item_ID of this box is set to indicate a G-PCC item of type ‘gpel’, ‘gpeb’, or ‘gpcl’ that carries the G-PCC geometry component.

A G-PCC item of type ‘gpel’ or ‘gpcl’ may be connected to a single image property of type ‘subs’.

GPCCItemData may be structurally identical to the syntax of a G-PCC sample.

The syntax of a G-PCC item is as follows:

aligned(8) class GPCCItemData
{
unsigned int GPCCLength = item_size; / Size of item
for (i=0; i< GPCCLength; ) / to end of the item
{
tlv_encapsulation gpcc_unit;
i += (1+4)+ gpcc_unit.tlv_num_payload_bytes;
}
}

The value of item_size is equal to the sum of the values of Extent length for each range of the item as specified in ItemLocationBox.

gpcc_unit contains a single G-PCC unit. The syntax of the G-PCC unit is specified in Annex B of ISO/IEC 23090-9 [GPCC].

The G-PCC tile item of an image item is described below:

The G-PCC tile item contains all G-PCC component data for one or more G-PCC tiles and is stored as an item of type ‘gptl’. The G-PCC tile item is formatted as a series of G-PCC units, where each G-PCC unit corresponds to a G-PCC tile representing a rectangular cuboid within the G-PCC bounding box of the G-PCC data. This item does not include any parameter set.

Each G-PCC tile item of type ‘gptl’ is associated with GPCCTileInfoProperty. The GPCCTileInfoProperty indicates the number of G-PCC tiles and the identifiers of the G-PCC tiles present in the associated G-PCC tile item.

A G-PCC tile item may be connected to one image property of type ‘subs’. When a ‘subs’ item property is connected to a G-PCC tile item, the tile identifier of the ‘subs’ item property is identical to the tile identifier of the ‘gpti’ item property connected to the same G-PCC tile item.

Note: G-PCC tile items may be included in a file to allow fast data retrieval without analyzing the layout of G-PCC units of the G-PCC data. For finer representation and/or more general representation of G-PCC tiles, sub-sample information may be used. For example, sub-sample information is suitable for indicating the identifiers of G-PCC tiles included in a G-PCC tile item.

The image properties are configured as follows:
G-PCC configuration item property of the image property
Box type:
‘gpcC’
Property type: Descriptive item property
Container: ItemPropertyContainerBox
Mandatory (per item): Yes, for an image item of type ‘gpel’, ‘gpeb’, or ‘gpcl’
Quantity (per item): One for an image item of type ‘gpel’, ‘gpeb’, or ‘gpcl’

Each G-PCC image item of type ‘gpel’, ‘gpeb’, or ‘gpcl’ has the same related property as the GPCCCConfigurationBox.

The essential has a value of 1 for a ‘gpcC’ item property associated with an image property of type ‘gpel’ or ‘gpeb’.
G-PCC component information item property of the image property
Box type:
‘ginf’
Property type: Descriptive item property
Container: ItemPropertyContainerBox
Mandatory (per item): Yes, for an image item of type ‘gpcl’
Quantity (per item): One for an image item of type ‘gpcl’

This item property indicates the type of G-PCC components contained in the corresponding G-PCC item. The box may also provide the attribute names, indices, and optional attribute types of G-PCC attribute components carried by each G-PCC item. This item property is identical to the GPCCComponentTypeBox.

The essential may have a value of 1 for a ‘ginf’ item property associated with a G-PCC item of type ‘gpcl’. The G-PCC component information item property is not associated with image items of type ‘gpel’ or ‘gpeb’.
G-PCC spatial region item property of the image property
Box type: ‘gpsr’
Property type: Descriptive item property
Container: ItemPropertyContainerBox
Mandatory (per item): Yes, for an image item of type ‘gpeb’ or ‘gpel’
Quantity (per item): Exactly One for an image item of type ‘gpeb’ or ‘gpel’

The descriptive item property of GPCCSpatialRegionInfoProperty is used to describe spatial region information and related tile information. This item property includes the total number of 3D spatial regions present in the G-PCC data, along with region identifiers, a reference point, and the size of the 3D spatial region in a Cartesian coordinate system based on the X, Y, and Z axes. The reference point is provided for each spatial region. The item property of GPCCSpatialRegionInfoProperty includes the identifiers of tiles associated with respective 3D spatial regions.

The syntax of the G-PCC spatial region item property is configured as follows:

aligned(8) class GPCCSpatialRegionInfoProperty
extends ItemFullProperty(‘gpsr’, 0, 0)
{
unsigned int(16)num_regions;
for(int i=0; i< num_regions; i++){
GPCCSpatialRegionStruct( );
unsigned int(8) num_tiles;
for(int j=0; j < num_tiles; j++){
unsigned int(16) tile_id;
}
}
}
num_regions indicates the number of spatial regions.

GPCCSpatialRegionStruct provides 3D spatial region information, represented by a spatial region identifier, an anchor point, and the size of the spatial region along the X, Y, and Z axes with respect to the anchor point.

Tile_id indicates the tile identifier of the 3D tile associated with the 3D spatial region.

The sub-sample item property of an image property is described below:

According to ISO/IEC 23008-12, the following constraints apply.

This item property represents exactly the same related property as SubSampleInformationBox with a flag equal to 1.

A sub-sample item property is not associated with an image item of type ‘gpeb’.

The G-PCC tile information item property of an image property is configured as follows:
Box type:
‘gpti’
Property type: Descriptive item property
Container: ItemPropertyContainerBox
Mandatory (per item): Yes, for an image item of type ‘gptl’
Quantity (per item): Exactly one for an image item of type ‘gptl’

The descriptive item property of GPCCTileInfoProperty is used to describe the tile identifiers of the 3D tiles present in the related G-PCC tile item. The item property of GPCCTileInfoProperty may include the total number of tiles in the associated G-PCC tile item and the tile identifiers of the tiles.

The syntax of the G-PCC tile information item property is configured as follows:

aligned(8) class GPCCTileInfoProperty
extends ItemFullProperty(‘gpti’, 0, 0)
{
unsigned int(16) num_tiles;
for(int i=0; i< num_tiles; i++){
unsigned int(16) tile_id;
}
}

num_regions indicates the number of G-PCC tiles present in the associated G-PCC tile item.

tile_id indicates the identifier of a G-PCC tile present in the associated G-PCC tile item.

Regarding dynamic level of detail information signaling, this metadata track indicates the dynamically changing level of detail related to point cloud data over time. It includes a ‘cdsc’ track reference to a track carrying the G-PCC geometry bitstream.

The structure of the sample entry is configured as follows:

aligned(8) class LevelOfDetailInfoBox( ) {
unsigned int(32) max_num_lod;
unsigned int(1) initial_lod_enabled flag;
unsigned int(1) suggested_lod_enabled_flag;
bit(6) reserved = 0;
if(initial_lod_enabled_flag)
unsigned int(32) initial_lod;
if(suggested_lod_enabled_flag)
unsigned int(32) suggested_lod;
}
aligned(8) class DynamicLevelOfDetailSampleEntry
extends MetaDataSampleEntry(‘gpdl’) {
LevelOfDetailInfoBox lod_info;
}
The sample format is as follows:
The sample syntax for this sample entry type (‘gpdl’) is specified as
follows:
aligned(8) class DynamicLevelOfDetailSample( ) {
LevelOfDetailInfoBox lod_info;
}

By signaling LevelOfDetailInfoBox information in a timed metadata track as described above, it may be signaled that LoD information may change on a per-frame basis. When the receiver parses the G-PCC content for the first time or cannot obtain the LoD information corresponding to the current frame, the LevelOfDetailInfoBox value included in the sample entry of the timed-metadata track, i.e., the DynamicLevelOfDetailSampleEntry may be referenced to determine the default values of the LoD information. The default values of the LoD information may be set as the initial values of max_num lod, initial lod, and suggested lod within the LevelOfDetailInfoBox, which may be applied to the very first frame of the G-PCC content and/or commonly applied to all frames constituting the G-PCC content.

The file of a G-PCC system supports partial access to G-PCC data based on the ISOBMFF format as follows:

As a common data structure, a 3D vector is included in the file.

The syntax of the 3D vector is configured as follows:

aligned(8) class Vector3(precision = 32) {
unsigned int(precision) x;
unsigned int(precision) y;
unsigned int(precision) z;
int reserved_bits = 8 − (precision*3) % 8;
if(reserved_bits != 8) {
const bit(reserved_bits) reserved;
}
}

x, y, and z specify the x, y, and z coordinate values of a 3D point in the Cartesian coordinate system, respectively.

As a common data structure, G-PCC bounding box information is included in the file.

GPCCBoundingBoxStruct provides bounding box information related to a 3D spatial region in Cartesian space.

The syntax of GPCCBoundingBoxStruct is configured as follows:

aligned(8) class GPCCBoundingBox(int bit dimensions_included_flag) {
unsigned int(8) bb_pos_precision;
Vector3 bb_position(bb_pos_precision);
if(dimensions_included_flag) {
unsigned int(8) bb_scale_precision;
Vector3 bb_scale(bb_scale_precision);
}
}

bb_position.x, bb_position.y, and bb_position.z indicate Cartesian coordinates along the x, y, and z axes of the anchor point in the 3D spatial region, respectively.

Dimensions_included_flag equal to 1 indicates that the size of the 3D spatial region along the x, y, and z axes with respect to the anchor point is signaled in the structure. Dimensions_included flag equal to 0 indicates that the dimensions of the 3D spatial region are not signaled in the structure.

bb_scale precision specifies the precision (in bytes) of bb_scale.

bb_scale.x, bb_scale.y, and bb_scale.z indicate the size of the 3D spatial region bounding box in Cartesian coordinates along the x, y, and z axes with respect to the anchor point, representing the width, height, and depth of the 3D spatial region.

As a common data structure, tile mapping information is included in the file.

This data structure provides a mapping between a G-PCC spatial region and one or more G-PCC tiles associated with the spatial region.

The syntax of the tile mapping information is configured as follows:

aligned(8) class TileMappingInfo( ) {
unsigned int(16) num_tiles;
for (j=0; j < num_tiles; j++) {
unsigned int(16) tile_id;
}
}

num_tiles indicates the number of G-PCC tiles associated with the G-PCC spatial region.

Tile_id identifies a G-PCC tile associated with the spatial region.

As a common data structure, G-PCC spatial region information is included in the file.

GPCCSpatialRegionStruct provides 3D spatial region information including an anchor point, and the size of the 3D spatial region along the x, y, and z axes in a Cartesian coordinate system with respect to the anchor point.

The syntax of GPCCSpatialRegionStruct is configured as follows:

aligned(8) class GPCCSpatialRegionStruct(dimension_included) {
unsigned int(32) size;
unsigned int(16) region_id;
unsigned int(1) bounding_box_present_flag;
unsigned int(1) dimensions_included_flag;
unsigned int(1) tm_present_flag;
unsigned int(5) reserved;
if(bounding_box_present_flag)
GPCCBoundingBox bounding_box(dimensions_included_flag);
if(tm_present_flag) {
TileMappingInfo tile_map( );
}
}

size is an integer specifying the number of bytes of this element, including all fields and the included element.

Region_id is the identifier of the spatial region.

bounding_box_present_flag indicates that bounding box information is present. For a synchronized sample of a dynamic spatial region metadata track, this flag is set to 1. For an asynchronous sample of the dynamic spatial region metadata track, this flag shall be set to 1 when the position and/or dimensions of this 3D region are updated, with reference to the previous synchronized sample.

Dimensions_included flag indicates that bounding box with a scale field is present. For a synchronized sample of a dynamic spatial region metadata sample, this flag is set to 1. For an asynchronous sample of the dynamic spatial region metadata sample, this flag is set to 1 only when the dimensions of this 3D region are updated with reference to the following: the previous synchronized sample. This flag may be set to 1 only when bounding_box_present_flag is set to 1.

tm_present_flag indicates that tile mapping information is present. For a synchronized sample of a dynamic spatial region metadata track, this flag is set to 1 if tile mapping information is available. For an asynchronous sample of the dynamic spatial region metadata track, this flag is set to 1 only when the related 3D tiles of this 3D region are updated with reference to the previous synchronized sample.

Partial Access of G-PCC data in ISOBMFF

As file information for partial access, static spatial region information is included in the file.
Box Types: ‘gpsr’
Container: GPCCSampleEntry (‘gpel’, ‘gpeg’, ‘gpcl’, ‘gpcg’, ‘gpeb’, ‘gpcb’) or DynamicGPCC3DSpatialRegionSampleEntry
Mandatory: No
Quantity: Zero or one

GPCCSpatialRegionInfoBox provides information about one or more 3D spatial regions and, when applicable, the association between the 3D spatial regions and the G-PCC tiles.

When GPCCSpatialRegionInfoBox is present in the sample entry of a G-PCC track delivering all G-PCC bitstreams or in the sample entry of a base G-PCC tile track, it indicates the static 3D spatial region information related to the G-PCC data delivered in the track or to each of all G-PCC tile tracks.

When both a G-PCC geometry track and a G-PCC attribute track are present, and GPCCSpatialRegionInfoBox is present in the sample entry of the G-PCC geometry track, this indicates the static 3D spatial region information related to the G-PCC data delivered in the G-PCC geometry track and the related G-PCC attribute track. The GPCCSpatialRegionInfoBox shall not be present in the sample entries of the associated G-PCC attribute tracks.

The syntax of the static spatial region information is configured as follows:

aligned(8) class GPCCSpatialRegionInfoBox extends FullBox(‘gpsr’,0,0){
unsigned int(16) num_regions;
for (int i=0; i < num_regions; i++) {
GPCCSpatialRegionStruct( );
}
}

num_regions indicates the number of 3D spatial regions.

GPCCSpatialRegionStruct provides 3D spatial region information and related G-PCC tile information.

A G-PCC file includes dynamic spatial region information signaling according to ISOBMFF.

A metadata track with a sample entry type of ‘gpdr’ indicates dynamically changing 3D spatial region information corresponding to part or all of the point cloud data, and the associations between regions and G-PCC tiles over time.

When a G-PCC track is associated with a dynamic spatial region temporal metadata track, the 3D spatial regions, the information of point cloud data carried by the track, or the association with G-PCC tiles are considered dynamic.

When this time-constrained metadata track is present, it includes a ‘cdsc’ track reference to a G-PCC track containing a G-PCC geometry bitstream or a G-PCC tile base track. When both a G-PCC geometry track and a G-PCC attribute track are present, the ‘cdsc’ track reference is included for the G-PCC geometry track rather than the G-PCC attribute track.

When GPCCSpatialRegionInfoBox is not present in the sample entry of a G-PCC tile base track, the dynamic spatial region temporal metadata track shall be present in the file and be associated with the G-PCC tile base track.

The syntax of the sample entry in a track containing dynamic spatial region information is configured as follows:

aligned (8) class DynamicGPCCSpatialRegionSampleEntry

extends MetaDataSampleEntry(‘gpdr”)
{
GPCCSpatialRegionInfoBoxregion_info( );
bit(6) reserved=0;
unsigned int(1) dynamic_dimension_flag;
unsigned int(1) dynamic_tile_mapping_flag;
}

GPCCSpatialRegionInfoBox indicates one or more pieces of initial 3D spatial region information.

Dynamic_dimension flag equal to 0 indicates that the dimensions of the 3D spatial regions remain unchanged in all samples referencing this sample entry.

Dynamic_dimension_flag equal to 1 indicates that the dimensions of the 3D spatial regions are specified in the samples.

Dynamic_tile_mapping_flag equal to 0 specifies that the identifiers of the G-PCC tiles associated with the 3D spatial regions remain unchanged in all samples referencing this sample entry. Dynamic_tile_mapping_flag equal to 1 specifies the identifiers of the G-PCC tiles associated with the 3D spatial regions present in the sample.

The format of samples in a track containing dynamic spatial region information is configured as follows:

Samples in the 3D spatial region temporal metadata track shall be set as either synchronous or asynchronous samples. At least one synchronous sample is present in the dynamic spatial region temporal metadata track.

A synchronous sample in the dynamic spatial region temporal metadata track delivers the dimensions of all G-PCC 3D spatial regions and related tile mapping information. In a synchronous sample for all spatial regions, the values of Dimensions included flag and bounding_box_present_flag are set to 1. When tile inventory information is available in the bitstream, the tm_present_flag is set to 1.

An asynchronous sample in the dynamic spatial region temporal metadata track signals only the updated 3D spatial region information, referencing the 3D spatial region information available from the nearest previous synchronous sample. The asynchronous sample signals only 3D spatial regions whose positions, sizes, or related G-PCC tiles have been updated, and any 3D spatial regions added or cancelled with reference to the nearest synchronous sample.

For an asynchronous sample in this temporal metadata track, if a 3D spatial region is cancelled with reference to the previous synchronous sample, cancelled_region_flag is set to 1. Dimensions_included flag is set to 1 only when the dimensions of the 3D spatial region in the current sample are updated with reference to the previous synchronous sample. When Dynamic_dimension_flag of the referenced sample entry is equal to 0, Dimensions_included_flag is set to 0.

bounding_box_present_flag is set to 1 only when the location and/or size of the 3D spatial region in the current sample are updated with reference to the previous synchronous sample. tm_present_flag is set to 1 only when the 3D tiles related to the 3D spatial region in the current sample are updated with reference to the previous synchronous sample. When Dynamic_tile_mapping_flag of the referenced sample entry is equal to 0, the tm_present_flag is set to 0.

The track containing dynamic spatial region information may further include a synchronous sample.

The syntax of the synchronous sample of this sample entry type ‘gpdr’ is configured as follows:

unsigned int(16) num_regions;
for (int i=0; i < num_regions; i++) {
GPCCSpatialRegionStruct spatial_region;
}
}

num_regions indicates the number of 3D spatial regions signaled in the synchronous sample.

When this sample is applied, spatial_region provides the 3D spatial region information related to the G-PCC data. Dimensions_included_flag and bounding_box_present_flag are set to 1. If tile inventory information is available, tm_present_flag is set to 1. Otherwise, tm_present_flag is set to 0.

The target is considered as the point cloud data associated with a sample in the reference track that has a composition time greater than or equal to the composition time of this sample and less than the composition time of the next sample.

A track containing dynamic spatial region information may further include non-synchronous samples.

The syntax of a non-synchronous sample is configured as follows:

aligned(8) DynamicGPCCSpatialRegionSample( ) {
unsigned int(16) num_regions;
for (int i=0; i < num_regions; i++) {
unsigned int(1) canceled_region_flag;
unsigned int(7) reserved;
if(!canceled_region_flag)
GPCCSpatialRegion spatial_region;
else
unsigned int(16) region_id;
}
}

num_regions indicates the number of updated 3D spatial regions signaled in the sample. A 3D spatial region whose dimensions and/or associated 3D tiles are updated with reference to the previous synchronous sample is considered an updated region. A 3D spatial region that is cancelled in the current sample with reference to the previous synchronous sample is also considered an updated region.

cancelled_region flag indicates whether a 3D region is cancelled or updated in the current sample with reference to the previous synchronous sample. A value of 1 indicates that the 3D region is cancelled with reference to the previous synchronous sample. The flag equal to 0 indicates that the sizes of the 3D region and/or related 3D tiles are updated with reference to the previous synchronous sample.

Spatial_region provides the 3D spatial region information related to the G-PCC data when this sample is applied. Dimensions_included flag is set to 1 only when the dimensions of the 3D region are updated with reference to the previous synchronous sample. When Dynamic_dimension_flag of the referenced sample entry is equal to 0, Dimensions_included_flag is set to 0. bounding_box present_flag is set to 1 only when the position and/or size of the 3D region is updated with reference to the previous synchronous sample. tm_present_flag is set to 1 only when the 3D tiles related to the 3D region are updated with reference to the previous synchronous sample. When Dynamic_tile_mapping_flag of the referenced sample entry is equal to 0, the tm_present_flag is set to 0.

Region_id identifies the 3D spatial regions that are cancelled with reference to the previous synchronous sample.

FIG. 28 illustrates a signaling method for a spatial region based on level of detail information according to embodiments.

The methods/devices according to the embodiments may signal the level of detail based on spatial regions within a frame containing point clouds, as shown in FIG. 28.

Geometry data may be encoded and decoded per slice (corresponding to data unit). It may also be decoded at different geometry occupancy tree (octree) depth levels. The point cloud receiver is capable of performing partial access per 3D spatial region. Accordingly, a level of detail value applicable to one or more tiles included in each 3D spatial region and to one or more slices corresponding to each tile may be added to pre-defined 3D spatial region signaling. The relationships among spatial regions, tiles, and slices are illustrated in FIG. 28.

A G-PCC frame may be composed of one or more spatial regions. Each of the spatial regions may include one or more G-PCC tiles. Each of the G-PCC tiles may include one or more slices.

According to the point cloud transmission/reception method, geometry data and attribute data about points included in slices may be encoded and decoded on a per slice basis. Therefore, the encoded bitstream is configured on a slice (or data unit) basis, and the point cloud is decoded on a per slice basis on the receiving side.

To transmit encoded bitstreams, the file format of the G-PCC system includes, for each spatial region, syntax representing the tiles contained in the spatial region as follows:

The syntax of the file for spatial regions is configured as follows:

aligned(8) class GPCCSpatialRegionStruct(dimension_included) {
unsigned int(32) size;
unsigned int(16) region_id;
unsigned int(1) bounding_box_present_flag;
unsigned int(1) dimensions_included_flag;
unsigned int(1) tm_present_flag;
unsigned int(1) region_based_lod_present_flag;
unsigned int(4) reserved;
if(bounding_box_present_flag)
GPCCBoundingBox bounding_box(dimensions_included_flag);
if(tm_present_flag) {
TileMappingInfo tile_map( );
}
if(region_based_lod_present_flag)
LevelOfDetailInfoBox lod_info( );
}

size indicates an integer specifying the number of bytes of this element, including all fields and contained elements.

region_id is an identifier of the spatial region.

bounding_box present_flag indicates that bounding box information is present. For a synchronous sample in a dynamic spatial region metadata track, this flag is set to 1. For an asynchronous sample in the dynamic spatial region metadata track, this flag is set to 1 when the position and/or dimensions of this 3D region are updated with reference to the previous synchronous sample.

dimensions_included flag indicates that bounding box with a scale field is present. For a synchronized sample of a dynamic spatial region metadata sample, this flag is set to 1. For an asynchronous sample of the dynamic spatial region metadata sample, this flag is set to 1 only when the dimensions of this 3D region are updated with reference to the following: the previous synchronized sample. This flag may be set to 1 only when bounding_box_present_flag is set to 1.

tm_present_flag indicates that tile mapping information is present. For a synchronized sample of a dynamic spatial region metadata track, this flag is set to 1 if tile mapping information is available. For an asynchronous sample of the dynamic spatial region metadata track, this flag is set to 1 only when the related 3D tiles of this 3D region are updated with reference to the previous synchronized sample.

region_based_lod present_flag indicates that level of detail information about the related spatial region is present.

lod info indicates the level of detail information about the related spatial region.

Further, the level of detail signaling information added to GPCCSpatialRegionStruct may also be applied to GPCCSpatialRegionInfoProperty of non-timed G-PCC items. Therefore, even when G-PCC content composed of a single G-PCC frame is encapsulated into an image item, the same or different level of detail information may be signaled for each 3D spatial region.

```
  aligned(8) class GPCCSpatialRegionInfoProperty extends
ItemFullProperty(‘gpsr’, 0, 0) {
  unsigned int(16) num_regions;
  for(int i=0; i< num_regions; i++) {
  GPCCSpatialRegionStruct( );
  unsigned int(8) num_tiles;
  for(int j=0; j < num_tiles; j++) {
  unsigned int(16) tile_id;
  }
  }
  }
```

The operation of a point cloud reception device (or decoder) related to frame-level LoD signaling and spatial region-level LoD signaling is performed as described below:

As described above, LoD information may be signaled on a per-frame basis and/or per spatial region within a frame. A decoding scenario at the receiving side when both frame-level and spatial region-level LoD signaling are provided is described below.

In this case, frame-level LoD signaling may serve as baseline LoD signaling, while spatial region-level LoD signaling within the frame provides more detailed LoD signaling for each spatial region in the frame-level LoD signaling.

For example, suggested_lod is equal to 5 for a frame or frames in a specific interval, and one or more spatial regions are present within the one or more frames in the interval, the value of suggested_lod for the spatial regions of each frame cannot exceed the frame-level value of suggested_lod equal to 5.

In addition, when initial_lod is equal to 2 for a frame or frames in a specific interval, and one or more spatial regions are present in the one or more frames in the interval, initial lod for the spatial regions of each frame cannot be less than 2.

Further, when initial_lod is equal to 2 and suggested_lod is equal to 5 for frames or spatial regions in a specific interval, and one or more spatial regions are present in the one or more frames in the interval, a rule may be defined such that for the spatial regions of each frame, initial_lod shall be greater than or equal to 2 and suggested_lod may be signaled as a value less than or equal to 5.

Alternatively, it may be assumed that there is no correlation between LoD information signaled at the frame level and LoD information signaled at the spatial region level. LoD information may be applied for decoding and rendering according to resources, user selection, or other circumstances. That is, depending on the receiver, only frame-level LoD may be applied, or only spatial region-level LoD may be applied.

FIG. 29 illustrates a method of transmitting point cloud data according to embodiments.

The point cloud data transmission method/device according to embodiments may include and perform the operations of the transmission device 10000 and point cloud video encoder 10002 of FIG. 1, the encoding 20001 of FIG. 2, the encoder of FIG. 4, the transmission device of FIG. 12, the audio encoding, point cloud encoding, file/segment encapsulation of FIG. 14, the point cloud encoding, file/segment encapsulation, delivery of FIG. 15, the various devices of FIG. 17, the bitstream generation of FIGS. 18 to 24, the sample entries and sample generation in tracks of a file of FIGS. 25 to 27, the level-of-detail signaling based on a spatial region of FIG. 28, and the transmission method of FIG. 29.

The point cloud data transmission method according to the embodiments may include encoding point cloud data (S2900).

The point cloud data transmission method according to the embodiments may further include encapsulating the point cloud data (S2910).

The point cloud data transmission method according to the embodiments may further include transmitting the point cloud data (S2920).

The encoding (S2900), as illustrated in FIG. 18, includes encoding geometry of the point cloud data on a slice basis and encoding attributes of the point cloud data on the slice basis. The encoded point cloud data is included in a bitstream. The bitstream may further contain parameters related to the point cloud data.

Referring to FIGS. 19, 20, 21, 22, and 23, the parameters may include at least one of a sequence parameter set, a tile inventory, a geometry parameter set, or an attribute parameter set. The bitstream may further contain a geometry data unit and geometry data unit header related to the geometry, and an attribute data unit and attribute data unit header related to the attributes.

The encapsulating the point cloud data (S2910) may include encapsulating the bitstream into one or more tracks of a file. A sample in the tracks related to the point cloud data may include at least of the geometry or the attribute. A sample group related to the sample may include level of detail information related to the point cloud data included in the sample.

The level of detail information may include at least one of information (max_num_lod) indicating a maximum number of levels for the point cloud data in the sample, information (initial_lod_enabled_flag) indicating whether an initial level is present, information (suggested_lod_enabled_flag) indicating whether a proposed level is present, information (initial_lod) indicating the initial level for the point cloud data in the sample, or information (suggested_lod) indicating the proposed level for the point cloud data in the sample.

Referring to FIG. 28, the encapsulating point cloud data (S2910) may include, based on the point cloud data being non-timed data, generating an item for an image of the point cloud data. Spatial region item property information related to the item may include spatial region information. The spatial region information may further include level of detail information related to a spatial region.

The encapsulating the point cloud data (S2910) may include generating spatial region information related to spatial regions of the point cloud data. The spatial region information may include at least one of identification information (region_id) identifying the spatial regions, bounding box information (bounding box) related to the spatial regions, or level of detail information (LevelOfDetailInfoBox lod_info) related to the spatial regions. The level of detail information (LevelOfDetailInfoBox lod_info) related to the spatial regions may include at least one of information (max_num_lod) indicating a maximum number of levels for the point cloud data in a sample, information (initial_lod_enabled_flag) indicating whether an initial level is present, information (suggested_lod_enabled_flag) indicating whether a suggested level is present, information (initial_lod) indicating the initial level for the point cloud data in the sample, or information (suggested_lod) indicating the suggested level for the point cloud data in the sample.

Regarding the encapsulation (S2910), the file encapsulation or file encapsulator (e.g., the file/segment encapsulation module) may generate and store tracks in a file according to the degree of change of parameter sets present in the G-PCC bitstream and may store related signaling information (e.g., signaling information contained in the bitstream). When generating a file, the file encapsulation or file encapsulator may add the suggested signaling information to one or more tracks in the file in cases, such as generating a media track containing a part or the entirety of the G-PCC bitstream or a metadata track associated with the G-PCC bitstream.

The point cloud data transmission method is performed by a transmission device. The transmission device may include a memory and a processor configured to execute one or more instructions stored in the memory. The processor may perform operations including encoding the point cloud data, encapsulating the point cloud data, and transmitting the point cloud data.

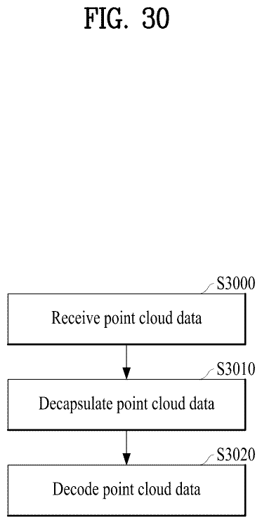

FIG. 30 illustrates a method of receiving point cloud data according to embodiments.

The point cloud data reception method/device according to embodiments may include and perform the operations of the reception device 10004, point cloud video decoder 10006 of FIG. 1, the decoding 20003 of FIG. 2, the decoders of FIGS. 10 and 11, the reception device of FIG. 13, the audio decoding, point cloud decoding, file/segment decapsulation of FIG. 14, the point cloud decoding, file/segment decapsulation of FIG. 16, the various devices of FIG. 17, the bitstream parsing of FIGS. 18 to 24, the sample entries and sample parsing in tracks of a file of FIGS. 25 to 27, the level-of-detail signaling based on a spatial region of FIG. 28, and the reception method of FIG. 29.

The point cloud data reception method according to the embodiments may include receiving point cloud data (S3000).

The point cloud data reception method may further include decapsulating the point cloud data (S3010).

The point cloud data reception method may further include decoding the point cloud data (S3020).

The receiving the point cloud data (S3000) may include receiving a file containing one or more tracks including a bitstream, the bitstream containing the point cloud data. The bitstream may contain geometry of the point cloud data based on slices. The bitstream may further contain an attribute of the point cloud data based on the slices. The bitstream may further contain parameters related to the point cloud data.

The decapsulating the point cloud data (S3010) may include decapsulating the bitstream in the file. A sample in the tracks related to the point cloud data may include at least one of the geometry or the attribute. A sample group related to the sample may include level of detail information related to the point cloud data included in the sample.

The level of detail information may include at least one of information (max_num_lod) indicating a maximum number of levels for the point cloud data in the sample, first information (initial_lod_enabled_flag) indicating whether an initial level is present, second information (suggested_lod_enabled_flag) indicating whether a suggested level is present, third information (initial_lod) indicating the initial level for the point cloud data in the sample, or fourth information (suggested_lod) indicating the suggested level for the point cloud data in the sample.

The decapsulating the point cloud data (S3010) may include, based on the point cloud data being non-timed data, decapsulating an item for an image of the point cloud data. Spatial region item property information related to the item may include spatial region information. The spatial region information may include level of detail information related to a spatial region

The decapsulating the point cloud data (S3010) may include decapsulating spatial region information related to spatial regions of the point cloud data. The spatial region information may include at least one of identification information identifying the spatial regions, bounding box information related to the spatial regions, or level of detail information related to the spatial regions. The level of detail information may include at least one of first information indicating whether an initial level is present, second information indicating whether a suggested level is present, third information indicating the initial level for the point cloud data in the sample, or fourth information indicating the suggested level for the point cloud data in the sample.

The file decapsulation (S3020) or file decapsulator according to the embodiments may effectively extract, decode, and post-process data in tracks of the file containing G-PCC content based on the value of level of detail signaling of the geometry data contained in the tracks. Described below is an embodiment of a process in which a point cloud receiver parses and decodes level of detail signaling using a sample grouping method.
1. The point cloud receiver receives G-PCC content or data encapsulated in a file.
2. It parses each track in the file and parses the data contained in the sample entry of the geometry track.
3. It may parse SampleGroupDescriptionBox with grouping_type set to ‘sgld’ to obtain LevelOfDetailInfoEntry data signaled in the SampleGroupDescriptionBox.
4. It may parse SampleToGroupBox included in the sample entry of the geometry track along with the SampleGroupDescriptionBox parsed in operation 3 to determine level of detail information to be applied to each sample. Each sample corresponds to one G-PCC frame, and thus level of detail information may be determined for each frame or for one or more consecutive frames.
5. After parsing in operation 4, the geometry data included in each sample is decoded up to the depth level corresponding to the value of the level of detail.

The point cloud reception method/device according to the embodiments may receive G-PCC content, parse signaled level of detail information based on 3D spatial regions, and then decode the point cloud based on the parsed information in the following procedure.
1. The point cloud receiver receives G-PCC content or data encapsulated in a file.
2. It may parse each track included in the file and parse the sample entries to find the geometry track.
3. Within the geometry track from operation 2, it the track ID connected to a track reference with reference_type of TrackReferenceTypeBox set to ‘cdsc’ may be identified. That is, a timed metadata track associated with the geometry track may be identified.
4. GPCCSpatialRegionStruct with a level of detail added to the sample entry of the timed metadata track may be signaled, and the point cloud receiver may parse this information. Thereby, the value of the level of detail corresponding to each 3D spatial region may be identified, and each value of level of detail, i.e., depth level may be applied to one or more tiles included in the 3D spatial region and one or more geometry slice data included in each tile only up to the corresponding depth level in performing decoding.
5. Through this process, different values of level of detail may be applied to the 3D spatial regions within the same G-PCC frame for decoding and rendering.

Embodiments may provide the following effects:

The embodiments may enable selecting tracks containing point cloud data within a file, or parsing, decoding, or rendering data within a track on a per-frame basis, depending on the level of detail value of the geometry data.

Accordingly, the G-PCC content creator may specify the level of detail intended to be presented to the user on a per-frame basis or based on a specific range of frames.

Further, unnecessary processing of unnecessary data, namely, point cloud data corresponding to frames with lower level of detail may be reduced. In other words, by decreasing the depth to which the geometry occupancy tree is parsed, parsing, decoding, and rendering of the point cloud data in the file may be performed more efficiently.

The spatial region-based signaling method may provide the following effects.
1. In the production process including capturing and post-processing G-PCC content, a minimum level of detail value required by the creator for each object within a frame may be delivered to the point cloud receiver. That is, level of detail values suitable for each of 3D spatial regions requiring fine quality and 3D spatial regions requiring relatively coarse quality may be delivered.
2. Depending on the available resources and/or decoder performance of each point cloud receiver, the value of max_num_lod at the file level may be referenced at the file level before decoding the G-PCC bitstream included in each sample. Thereby, in decoding one or more tiles in a region and one or more geometry slices included in each tile, the value of level of detail to apply within the value of max num_lod may be determined.
3. The described method may be used together with a scenario in which a viewport is changed through manipulations such as up, down, left, and right movements, rotation, and/or zoom-in or zoom-out by a user consuming G-PCC content using the point cloud receiver. When decoding and rendering the received G-PCC content, the point cloud receiver may arbitrarily set a relatively lower level of detail for 3D spatial regions located farther away from the viewport perspective, and may parse an occupancy tree with a lower depth value for one or more tiles belonging to the corresponding 3D spatial region and one or more geometry slice data belonging to each tile. That is, the level of detail corresponding to a 3D spatial region located farther away from the user's line of sight may be lowered. In addition, the point cloud receiver may be allowed to use fewer resources and the decoding speed may be increased.
4. The level of detail information corresponding to effects 1 to 3 above may be dynamically signaled on a per-frame basis.
5. Even when the level of detail information corresponding to effects 1 to 3 above is configured together with G-PCC fused data in a single frame and encapsulated in a G-PCC Image item, it may still be delivered by signaling.

According to embodiments, a transmitter (or file encapsulator) for providing point cloud content services configures a G-PCC bitstream and stores the same in a file as described above. In addition, the transmitter defines a G-PCC sample and stores same in the file. The transmitter may also store sub-samples in the G-PCC bitstream file. Accordingly, a receiver for providing point cloud content services may efficiently access the stored G-PCC bitstream.

The methods according to the embodiments may allow effective multiplexing of the G-PCC bitstream. Further, the methods or approaches according to the embodiments may support efficient access to the bitstream on a G-PCC access unit basis.

The methods or approaches according to the embodiments may allow metadata for processing and rendering of data in the G-PCC bitstream to be transmitted in the bitstream.

A point cloud compression processing device, transmitter, receiver, point cloud player, encoder, or decoder according to embodiments performs one or more operations or methods to provide the above-described effects.

The methods or approaches according to the embodiments may enable point cloud video to be effectively reproduced during playback. Further, they may allow a user to interact with the point cloud video. In addition, they may allow the user to change playback parameters.

In other words, the above-described data representation method may enable efficient access to the point cloud bitstream.

A transmitter or receiver according to embodiments may efficiently store and transmit a file of a point cloud bitstream using a technique of dividing and storing the G-PCC bitstream into one or more tracks in the file and signaling the same, and signaling for indicating relationships among the multiple tracks of the stored G-PCC bitstream.

The methods/devices according to the embodiments described above may be described in combination with the G-PCC data delivery methods and devices described below.

The data of the G-PCC and G-PCC system described above may be generated by an encapsulator (also referred to as a generator, etc.) of the transmission device according to embodiments and transmitted by the transmitter of the transmission device. In addition, the data of the G-PCC and G-PCC system described may be received by a receiver of the reception device according to embodiments and acquired by a decapsulator (also referred to as a parser, etc.) of the reception device. The decoder, renderer, and the like of the reception device may provide suitable point cloud data to a user based on the data of the G-PCC and G-PCC system described above.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

As described above, related contents have been described in the best mode for carrying out the embodiments.

As described above, the embodiments may be fully or partially applied to the point cloud data transmission/reception device and system.

It will be apparent to those skilled in the art that variously changes or modifications can be made to the embodiments within the scope of the embodiments.

Thus, it is intended that the embodiments cover the modifications and variations of this disclosure provided they come within the scope of the appended claims and their equivalents.

1. A method of transmitting point cloud data, the method comprising:
encoding point cloud data;
encapsulating the point cloud data; and
transmitting the point cloud data.

2. The method of claim 1, wherein the encoding of the point cloud data comprises:
encoding geometry of the point cloud data based on slices; and
encoding an attribute of the point cloud data based on the slices,
wherein the encoded point cloud data is included in a bitstream,
wherein the bitstream further contains parameters related to the point cloud data.

3. The method of claim 2, wherein the parameters comprise at least one of a sequence parameter set, a tile inventory, a geometry parameter set, or an attribute parameter set,
wherein the bitstream further contains a geometry data unit and a geometry data unit header related to the geometry,
wherein the bitstream further contains an attribute data unit and an attribute data unit header related to the attribute.

4. The method of claim 2, wherein encapsulating of the point cloud data comprises encapsulating the bitstream into one or more tracks of a file,
wherein:
a sample in the tracks related to the point cloud data comprises at least one of the geometry or the attribute; and
a sample group related to the sample comprises level of detail information related to the point cloud data included in the sample.

5. The method of claim 4, wherein the level of detail information comprises at least one of:
information indicating a maximum number of levels for the point cloud data in the sample;
information indicating whether an initial level is present;
information indicating whether a suggested level is present;
information indicating the initial level for the point cloud data in the sample; or
information indicating the suggested level for the point cloud data in the sample.

6. The method of claim 2, wherein the encapsulating of the point cloud data comprises:
based on the point cloud data being non-timed data, generating an item for an image of the point cloud data,
wherein spatial region item property information related to the item comprises spatial region information,
wherein the spatial region information comprises level of detail information related to a spatial region.

7. The method of claim 2, wherein the encapsulating of the point cloud data comprises:
generating spatial region information related to spatial regions of the point cloud data,
wherein the spatial region information comprises at least one of:
identification information identifying the spatial regions;
bounding box information related to the spatial regions; or
level of detail information related to the spatial regions.

8. The method of claim 7, wherein the level of detail information comprises at least one of:
information indicating a maximum number of levels for the point cloud data in a sample;
information indicating whether an initial level is present;
information indicating whether a suggested level is present;
information indicating the initial level for the point cloud data in the sample; or
information indicating the suggested level for the point cloud data in the sample.

9. A transmission device, comprising:
a memory; and
a processor configured to execute one or more instructions included in the memory,
wherein the processor is configured to perform operations, the operations comprising:
encoding point cloud data;
encapsulating the point cloud data; and
transmitting the point cloud data.

10. A method of receiving point cloud data, the method comprising:
receiving point cloud data;
decapsulating the point cloud data; and
decoding the point cloud data.

11. The method of claim 10, wherein the receiving of the point cloud data comprises:
receiving a file containing one or more tracks including a bitstream, the bitstream containing the point cloud data,
wherein the bitstream contains geometry of the point cloud data based on slices,
wherein the bitstream further contains an attribute of the point cloud data based on the slices, and
wherein the bitstream further contains parameters related to the point cloud data.

12. The method of claim 10, wherein the decapsulating of the point cloud data comprises decapsulating the bitstream in a file,
wherein:
a sample in the tracks related to the point cloud data comprises at least one of geometry or an attribute; and
a sample group related to the sample comprises level of detail information related to the point cloud data included in the sample.

13. The method of claim 12, wherein the level of detail information comprises at least one of:
information indicating a maximum number of levels for the point cloud data in the sample;
first information indicating whether an initial level is present;
second information indicating whether a suggested level is present;
third information indicating the initial level for the point cloud data in the sample; or
fourth information indicating the suggested level for the point cloud data in the sample.

14. The method of claim 10, wherein the decapsulating of the point cloud data comprises:
based on the point cloud data being non-timed data, decapsulating an item for an image of the point cloud data,
wherein spatial region item property information related to the item comprises spatial region information,
wherein the spatial region information comprises level of detail information related to a spatial region.

15. A reception device, comprising:
a memory; and
a processor configured to execute one or more instructions stored in the memory,
wherein the processor is configured to perform:
receiving point cloud data;
decapsulating the point cloud data; and
decoding the point cloud data.
